(19) United States
(12) Patent Application Publication
(10) Pub. No.: US 2016/0117953 A1
(43) Pub. Date: Apr. 28, 2016

(54) System and Method for Remote Collaborative Learning

(71) Applicant: WS Publishing Group, Inc., San Diego, CA (US)

(72) Inventor: Alex Lluch, Poway, CA (US)

(21) Appl. No.: 14/731,538

(22) Filed: Jun. 5, 2015

Related U.S. Application Data
(60) Provisional application No. 62/139,764, filed on Mar. 29, 2015.
(60) Provisional application No. 62/067,877, filed on Oct. 23, 2014.

(51) Int. Cl. G09B 19/02; G09B 7/02; G09B 7/06; G09B 5/02

(52) U.S. Cl. CPC G09B 19/025; G09B 5/02; G09B 7/02; G09B 7/06

(57) ABSTRACT

A system and method are provided for using networked computer devices to access remote collaborative learning resources. The method uses a student computing device to establish a network-connection with an education program, accesses a problem set screen, and selects a problem. If an incorrect answer is submitted to the problem, the student application has the option of accessing a remote education program collaborative learning resource associated with the selected problem. Subsequent to accessing the collaborative learning resource, the student application submits a problem answer to the education program. In response to the resource flag and the submission of a correct problem answer, the education program grants partial credit to the student application or a user identity associated with the student application. Optionally, the problem answers may be submitted with a problem work area screen. The problem work area screen is frozen once the student application accesses a collaborative learning resource.

### RELATED APPLICATIONS

This application claims the benefit of Provisional application Ser. No. 62/139,764, filed Mar. 29, 2015, which is incorporated herein by reference.

This application claims the benefit of Provisional application Ser. No. 62/067,877, filed Oct. 23, 2014, which is incorporated herein by reference.

### BACKGROUND OF THE INVENTION

1. Field of the Invention

This invention generally relates to computer software and, more explicitly, to a system and method for implementing remote collaborative learning, enabled using networked computer software applications.

2. Description of the Related Art

U.S. Pat. No. 6,634,887 discloses tutoring a student in the form of a dialog, with a questions posed to the student and analysis of student responses. The method comprises the following steps: receiving the diagnosis in a tutorial processing module; generating an agenda including at least one question; applying at least one tutorial strategy to the diagnosis; and, providing feedback to the student based on application of the tutorial strategy given the current context as indicated by the agenda data structure.

U.S. Pat. No. 8,619,111 discloses a remote assistance system to communicate with, and manipulate mobile devices so as to transmit images or other visual data to the mobile phone that are then overlaid upon images presented on the mobile phone. This system does not provide any tutoring, peer help, or encourage a student to make corrections to a problem already tried but incorrectly solved.

US 2014/0162239 discloses a real-time interactive session between a tutor and a student using a virtual whiteboard, real-time messaging, and voice communications. The system does not preserve anonymity between the tutors and students, provide for any type of peer help, or provide a means for a teacher to monitor the interactions between student and tutor. Further, the system does not encourage the student to seek assistance in solving problems that are initially solved incorrectly.

US 2006/0226689 discloses a tutoring system having artificial intelligence, which enables a two-way conversation mode between a student at a computer station and the computing system thereby facilitating anytime one-on-one individual assistance for the student. Such a system is limited by the “intelligence” of the computer station. Further, the system lacks flexibility and must be reprogrammed for each new type of subject matter.

US 2003/0059761 discloses a program for assigning and correcting homework on-line based upon the authorization of and feedback from users. The program includes a homework assignment portion, a student tutorial portion, and various review and grading portions for use by authorized users. However, the system lacks student-tutor anonymity, peer help, the monitoring of student-tutor interactions, or any encouragement to seek assistance in making corrections to a problem already tried but incorrectly solved.

US 2012/0264099 discloses a computer-based online interactive educational system for a student and a tutor to facilitate instant discussions over a specific learning subject. However, the system lacks student-tutor anonymity, peer help, or any encouragement for the student to solve problems correctly or on their own before getting assistance.

It would be advantageous if a means existed of permitting students to try to solve a specific problem, and in the event of the problem being answered wrong, allowing the students to access learning aids such as peer examples, teachers' explanation, and online anonymous tutoring resources that could be monitored by the teacher. It would be advantageous if partial credit could be given for accessing this aid, and to permit teachers to monitor student efforts in attempting to resolve the problem both before getting help, if any, and after accessing the learning aids or tutoring assistance.

It would be advantageous if a means existed that permitted students to get help from other students or member of the community who would be willing to tutor them without monetary compensation and anonymously, so students would not afraid to ask stupid questions or be subjected to preferential/differential treatment.

It would be advantageous if a means existed of enabling remote communications between students and tutors in both real-time and asynchronously.

### SUMMARY OF THE INVENTION

The systems and methods disclosed herein describe a number of educational processes that were impractical before the advent of networked computer applications. Some of these education processes are as follows. Allowing students to see how other classmates solved a homework problem correctly, and rating the explanation of each problem as a means of motivating students to do a better job at explaining their answer. Giving a student partial credit (e.g., 50%) for any problem for which that student accesses the correct answer, and or gets help from a peer or teacher example or from a tutor. The submission of work area screens for specific problems also permits a teacher or tutor to see what a student understood before and after receiving help. In addition, the answer screens submitted by students differentiate between the problems for which the student got right, wrong, or accessed help.

If the student accesses tutoring help, the identities of the tutor and student may be anonymous, so that the tutors cannot give differential treatment. Anonymity also encourages students who may be afraid of asking “stupid” questions. Anonymity also permits the pool of certified tutors to include classmates, other students, professional educators, and community volunteers. Each tutoring session may be may be associated with a specific homework problem, so that the tutor may choose to work in fields in which they have confidence. Advantageously, the tutoring sessions may take place in real-time when participants are online at the same time, or asynchronously when the participants are not online at the same time. Likewise, student-tutor interactions may be reviewed in real-time or at a later time. Some tutoring sessions may be used as examples for other students to access.

Accordingly, a method is provided for using networked computer devices to access remote collaborative learning resources. The method uses a student computing device to establish a network-connection with an education server having an embedded education program. A student application, embedded in a student computing device, accesses a problem set screen in the education program, and selects a problem from the problem set screen. If an incorrect answer or no answer is submitted to the problem, the student application has the option of accessing a remote education program collaborative learning resource associated with the selected problem. Subsequent to accessing the collaborative learning resource, the system sets a resource flag and the student application submits a corrected problem answer to the education program. In response to the resource flag and the submission of a correct problem answer, the education program grants partial credit to the student application or a user identity associated with the student application. Optionally, the problem answers may be submitted with a problem work area screen. If so, the problem work area screen is frozen once the student application accesses a collaborative learning resource and a second problem work area created, so that the student's work, before and after accessing the collaborative learning resource, can be reviewed by a tutor or teacher.

Some examples of collaborative learning resources include example work sheets, the correct answer to the selected problem, and anonymous tutoring. The example work sheets may be created by fellow students, teachers, or be interactions between a tutor and a fellow student. Typically, the collaborative learning resource being accessed is associated with only one particular problem.

The student application accesses the anonymous tutoring collaborative learning resource by submitting a tutor request to the education program. The education program anonymously links the tutor request to the student application, and lists the tutor request on a tutoring billboard. A tutor computing device with a tutoring application establishes a network connection with the education program on the education server, accesses the tutoring billboard, and selects the tutor request. Alternatively, the system may send tutor request notices to a group of certified tutor applications. As noted above, a tutor request may be just associated with a particular problem. The tutoring application and student application interactively populate a tutoring work area screen, anonymously transceived with the first student application via the education program. Advantageously, the tutoring work area screen may be transceived in real-time or asynchronously, when the student and tutoring applications happen to be network-connected. The student application may submit a remedial work area screen to the education program for review and partial credit.

A teacher computing device with an embedded teacher application may establish a network connection with the education program to perform one of more of the following operations: accessing a frozen problem work area screen, accessing a tutoring work area screen, accessing a remedial work area screen, accessing a user identity associated with the tutor application, and accessing a user identity associated with the student application. The teacher application, through the education program, may monitor the tutor application, authorize tutoring application access privileges to the tutoring billboard, and certify user identities associated with a tutor application or example work sheet. The education program may grant tutoring credits to the user identity associated with the tutoring application, which may take the form of a financial reward, school credit, or community service hours.

Additional details of the above-described method, a method for using a networked computer to provide anonymous tutoring, and a system for providing remote collaborative learning resources are provided below.

### BRIEF DESCRIPTION OF THE DRAWINGS

FIGS. 1A and 1B are, respectively, conceptual and schematic block diagram of a system for providing remote collaborative learning resources.

FIG. 2 is a diagram representing an exemplary collaborative learning resources (CLR) center.

FIG. 3 is a diagram representing a tutoring billboard.

FIGS. 4A through 4AB are diagrams representing an exemplary student application graphical user interface (GUI).

FIG. 5 is a flowchart illustrating a method for using networked computer devices to provide access to remote collaborative learning resources.

### DETAILED DESCRIPTION

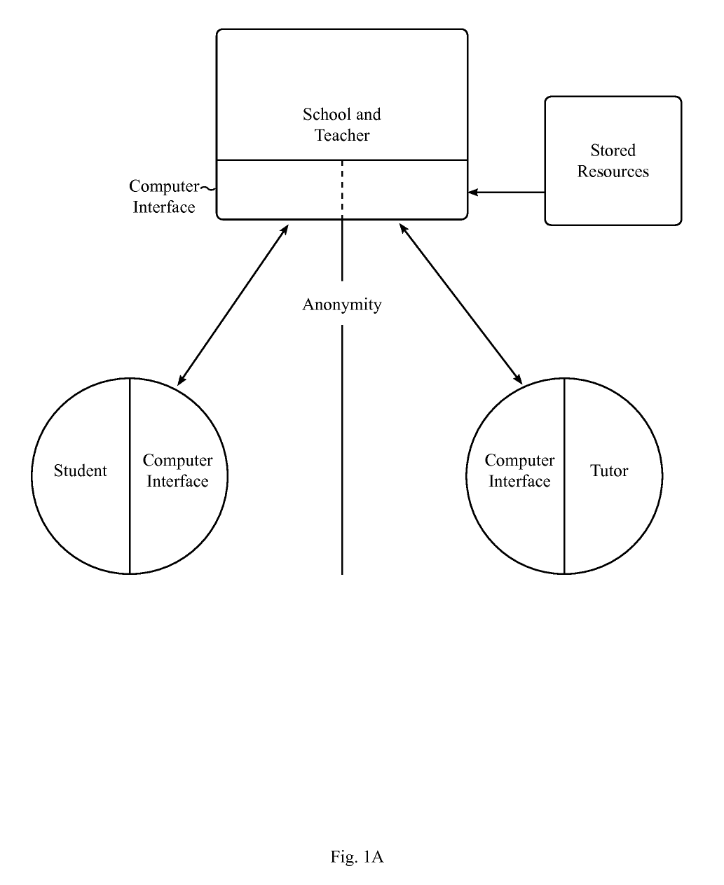

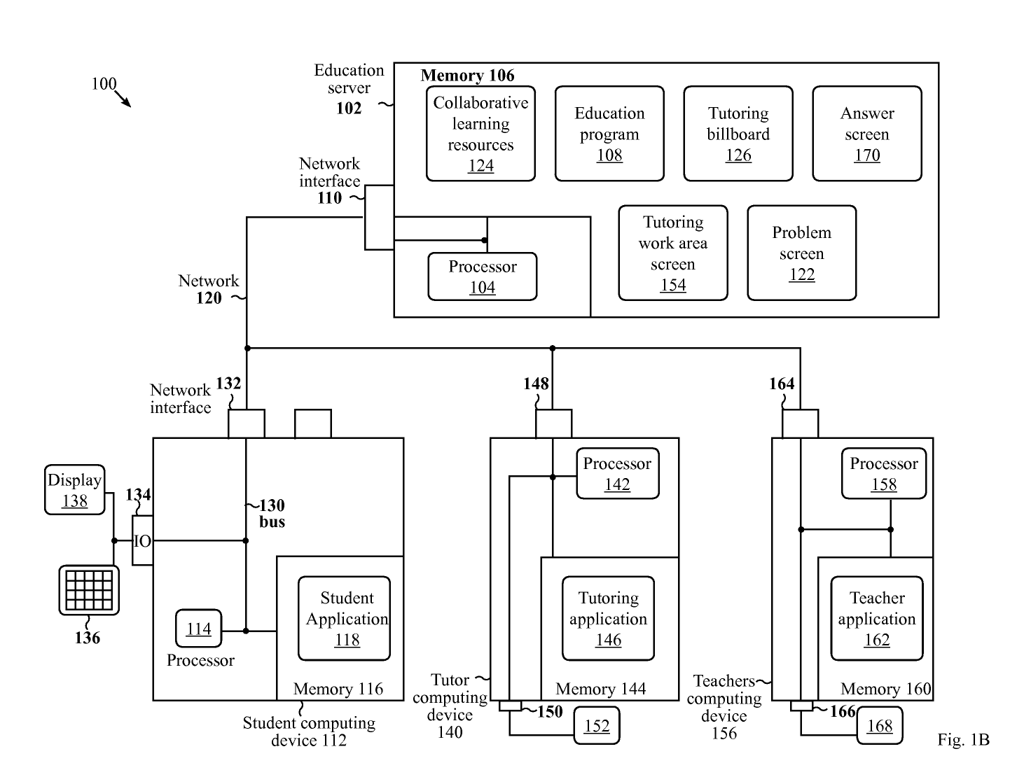

FIGS. 1A and 1B are, respectively, conceptual and schematic block diagrams of a system for providing remote collaborative learning resources. As can be seen in FIG. 1A, through the use of computer interfaces a student is able to access an education website that in turn grants the student access to help in the form of tutoring or stored resources (e.g., examples). Advantageously, by the education server controlling the interactions, communications between students and tutors can remain anonymous. Unlike conventional social media applications that promote connectivity at the expense of privacy, the systems described herein promote connectivity while protecting privacy. Simultaneous with protecting privacy, the education server may be used to monitor student access and use of the remote learning resources, post assignments, and uniquely grade assignment solutions submitted by the student in accordance with how much help they received. As described in detail below, the combination of remote access, anonymity, remedial testing, monitoring, and student participation are not simply human tasks that might be performed more quickly by a computer. Rather, they are new education functions, especially as combined, made possible through the use of a computer. Thus, the systems described herein do not broadly monopolize the abstract ideas of learning, testing, or tutoring.

In FIG. 1B the system 100 comprises an education server 102 comprising a processor 104, a non-transitory memory 106 embedding an education program 108 enabled as a sequence of processor executable instructions, and a network interface 110. A student computing device 112 comprises a processor 114, a non-transitory memory 116 embedding a student application 118 enabled as a sequence of processor executable instructions, and a network interface 132 connected to the education server 102 on line 120 (the network). Although only one student computing device is shown, the system 100 is not limited to any particular number of connected student computing devices. The network 120 may be an Internet, intranet, or local area network, as would be well known in the art. The network interface 132 may be a modem, an Ethernet card, IEEE 802.11, Bluetooth, or any other appropriate data communications device such as universal serial bus (USB). The physical communication links may be optical, wired, or wireless.

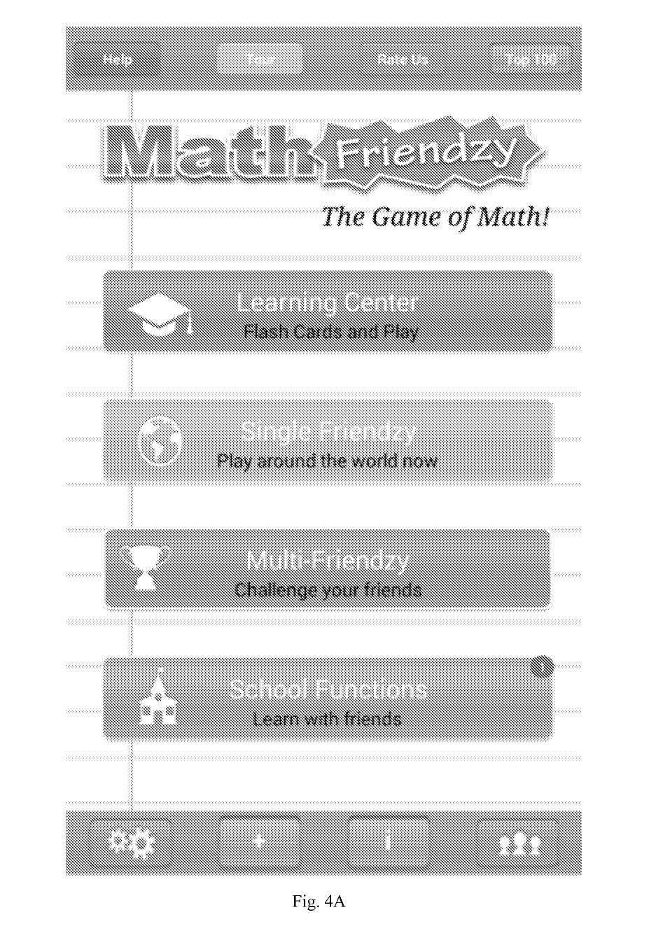

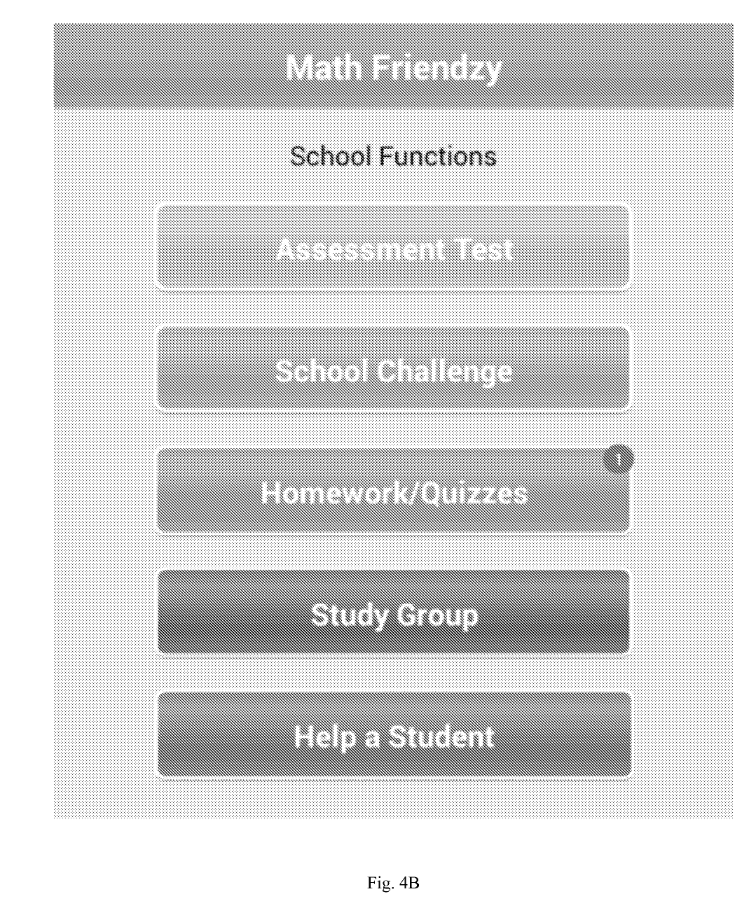

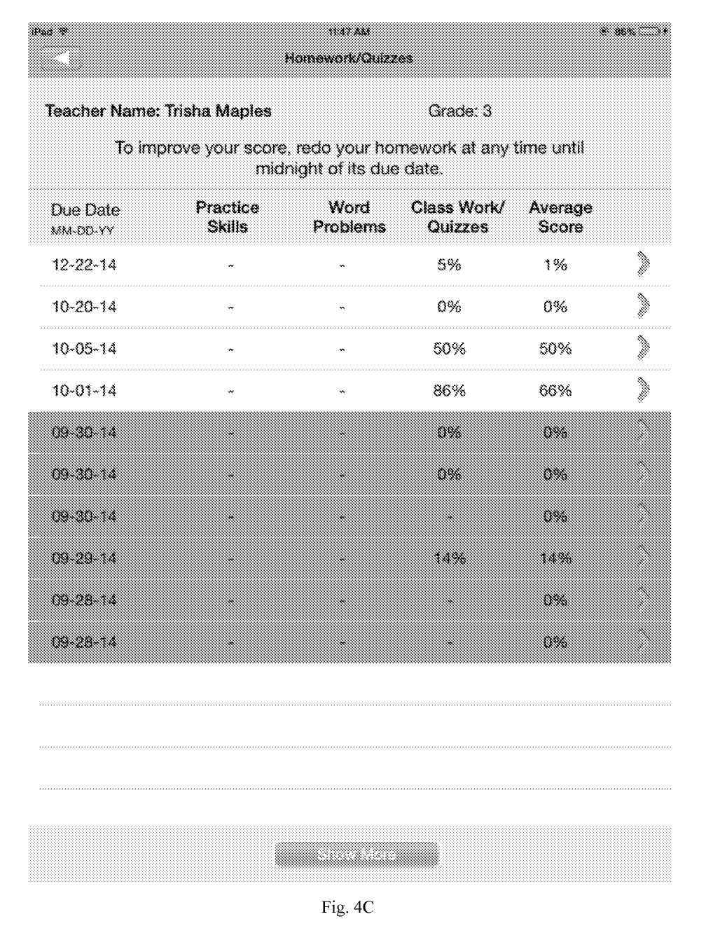

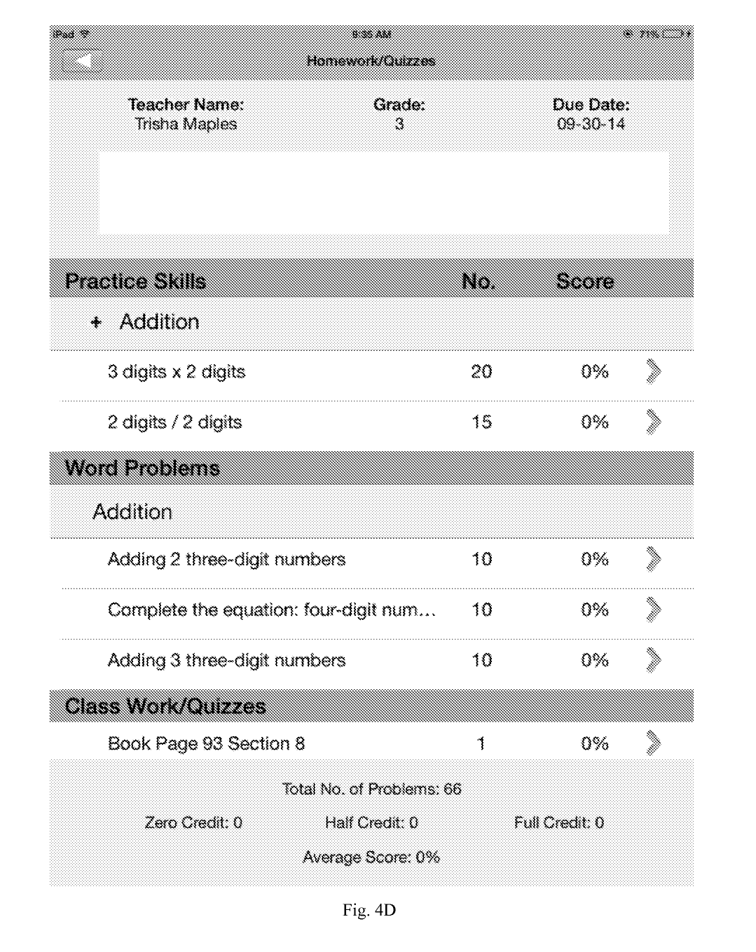

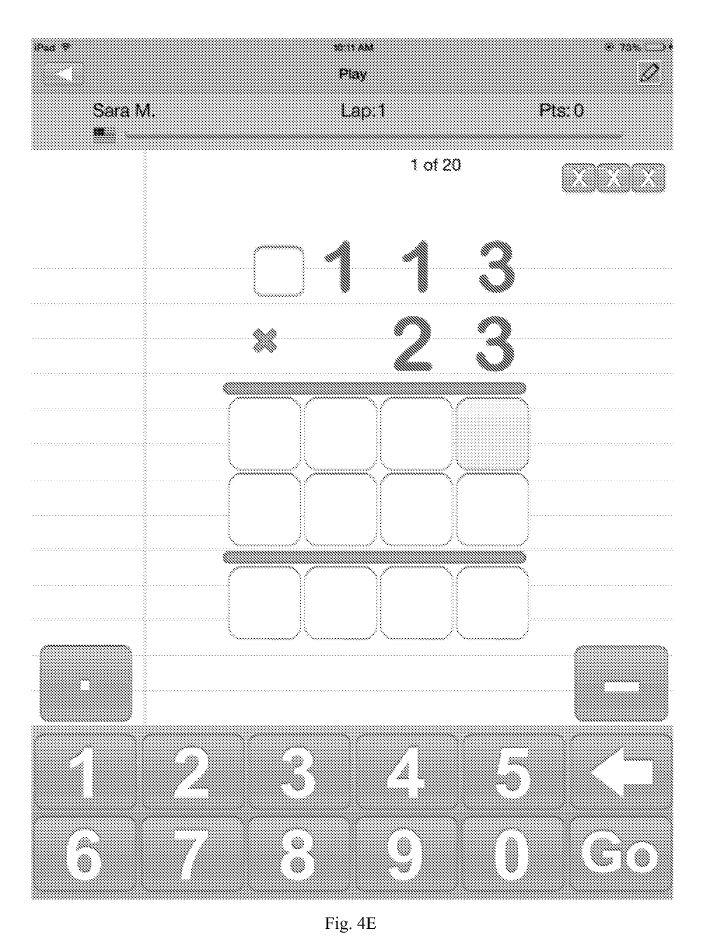

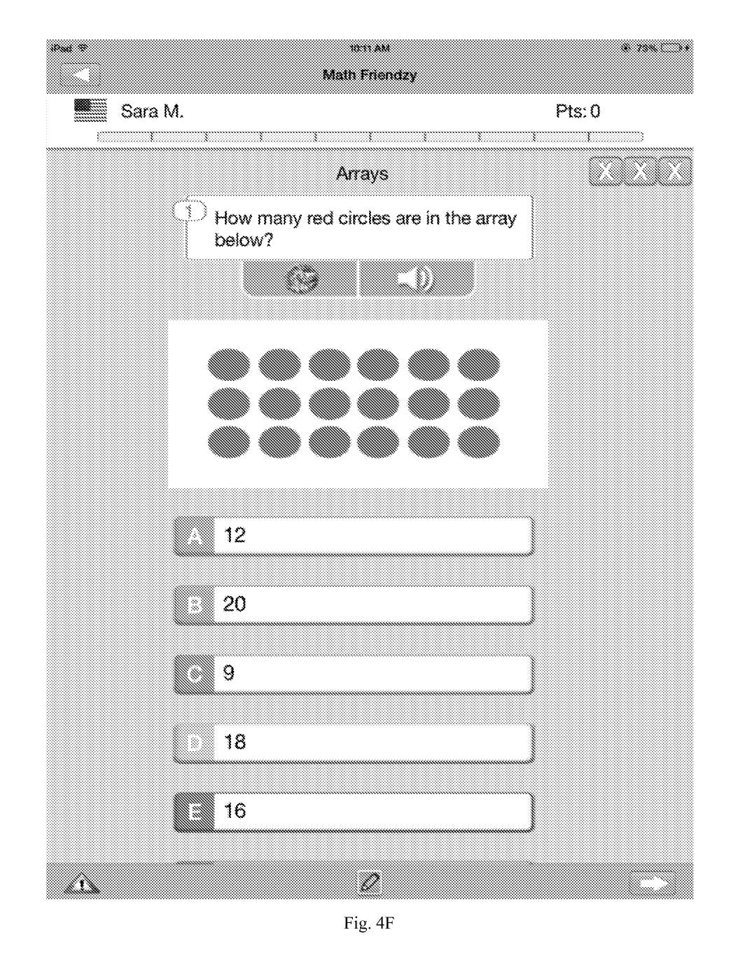

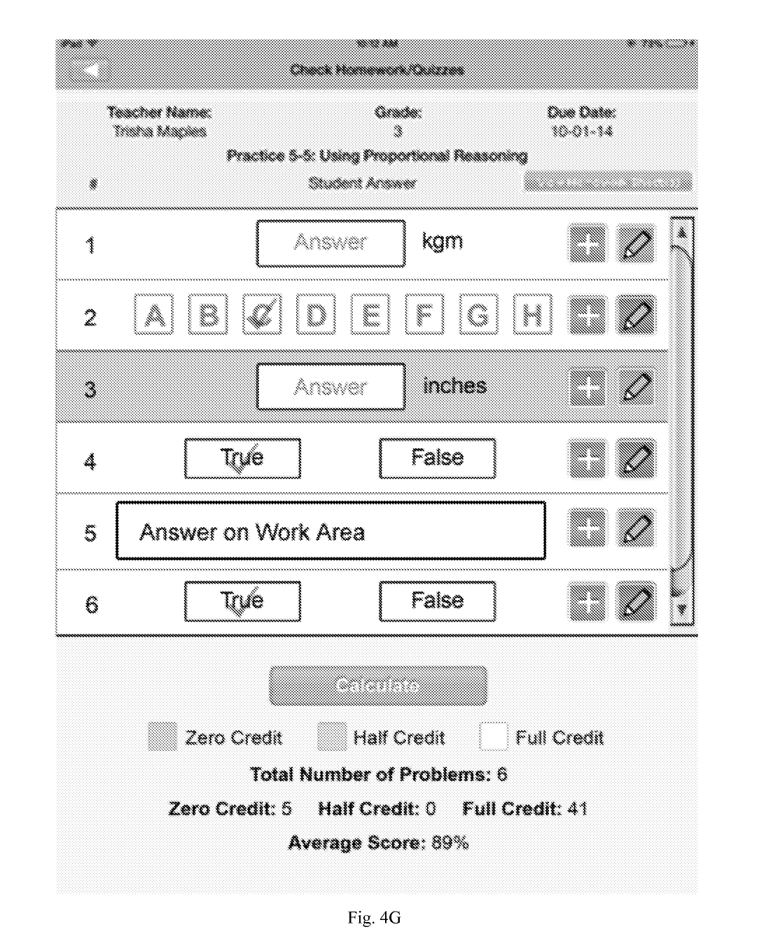

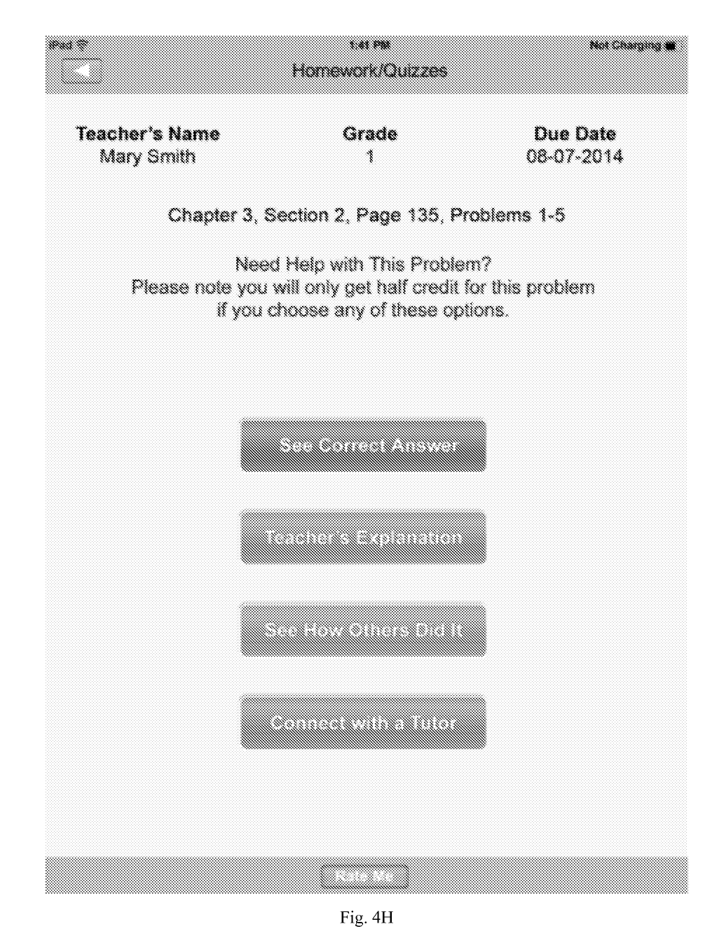

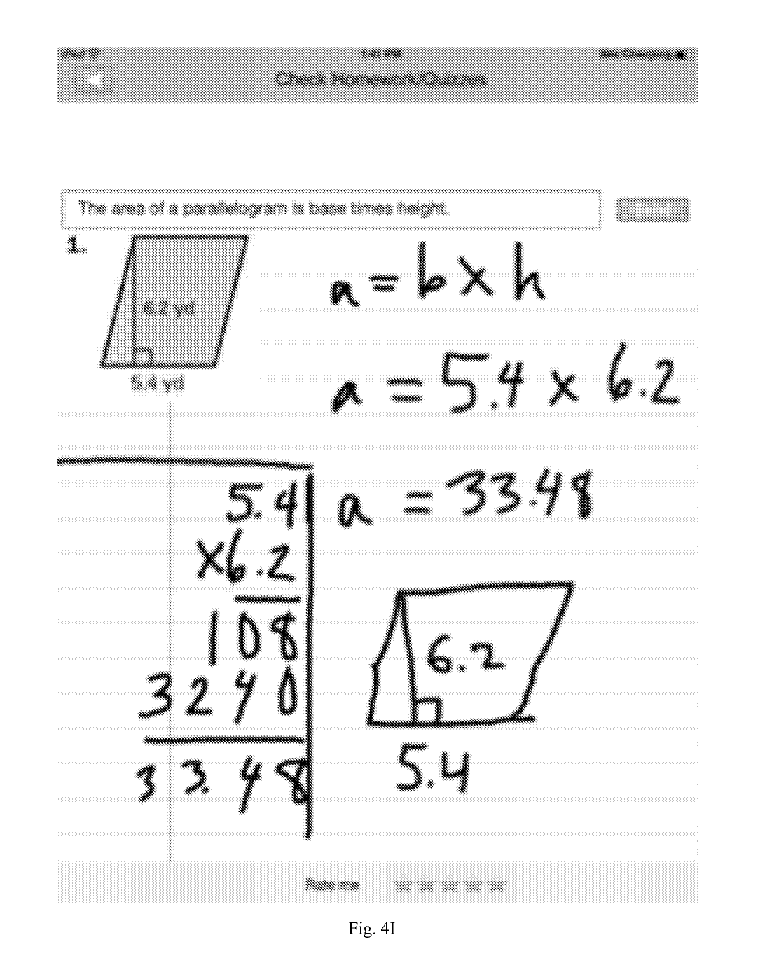

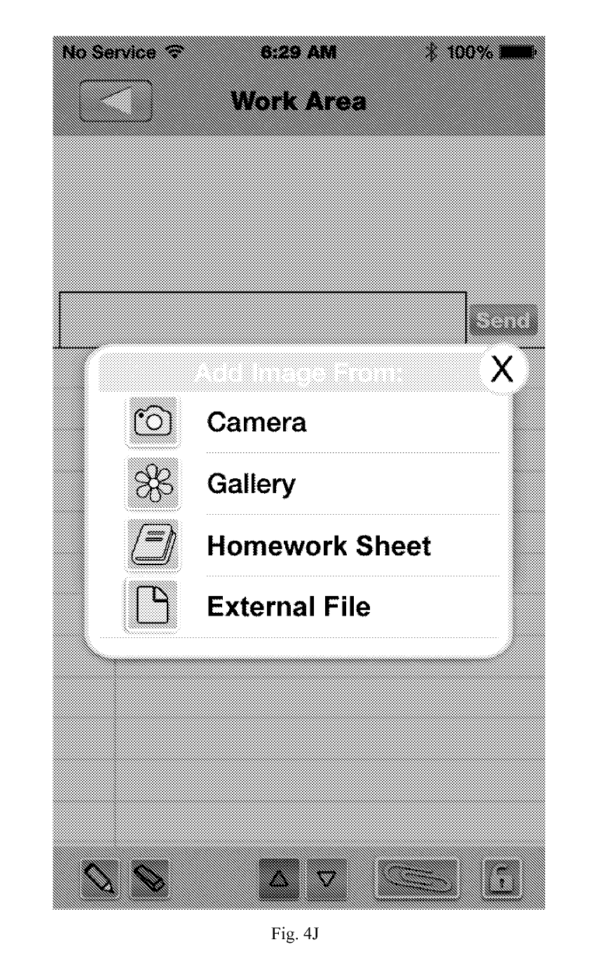

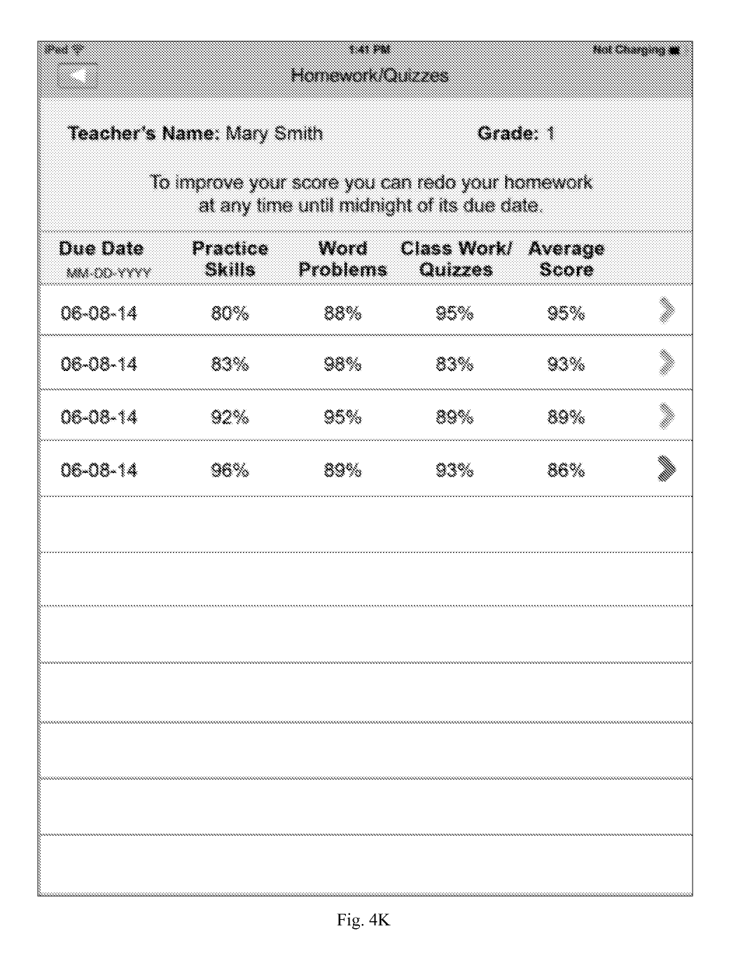

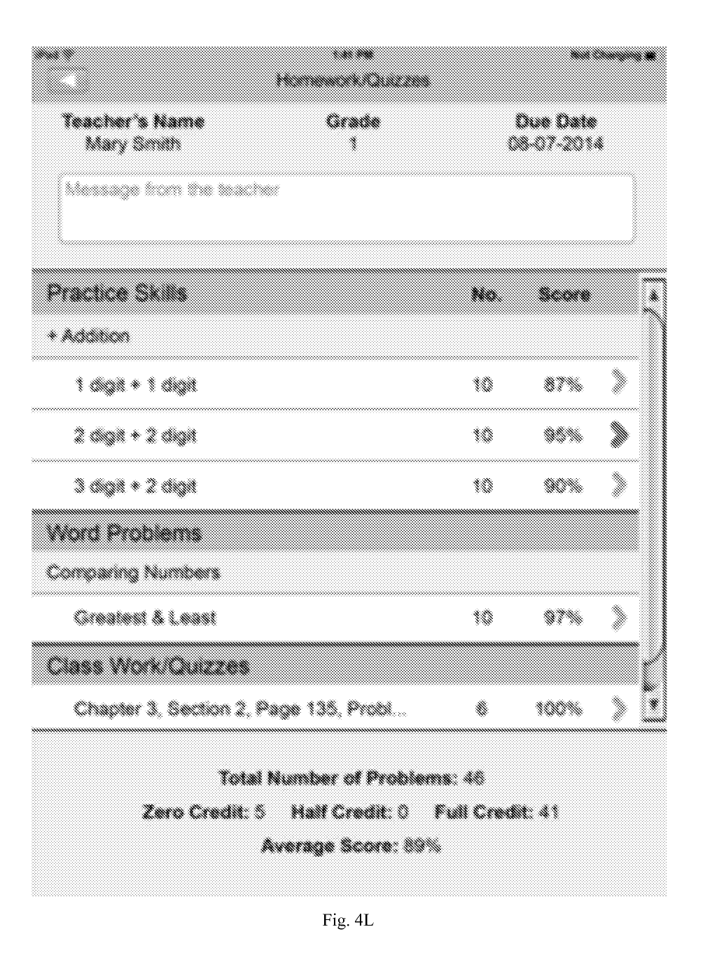

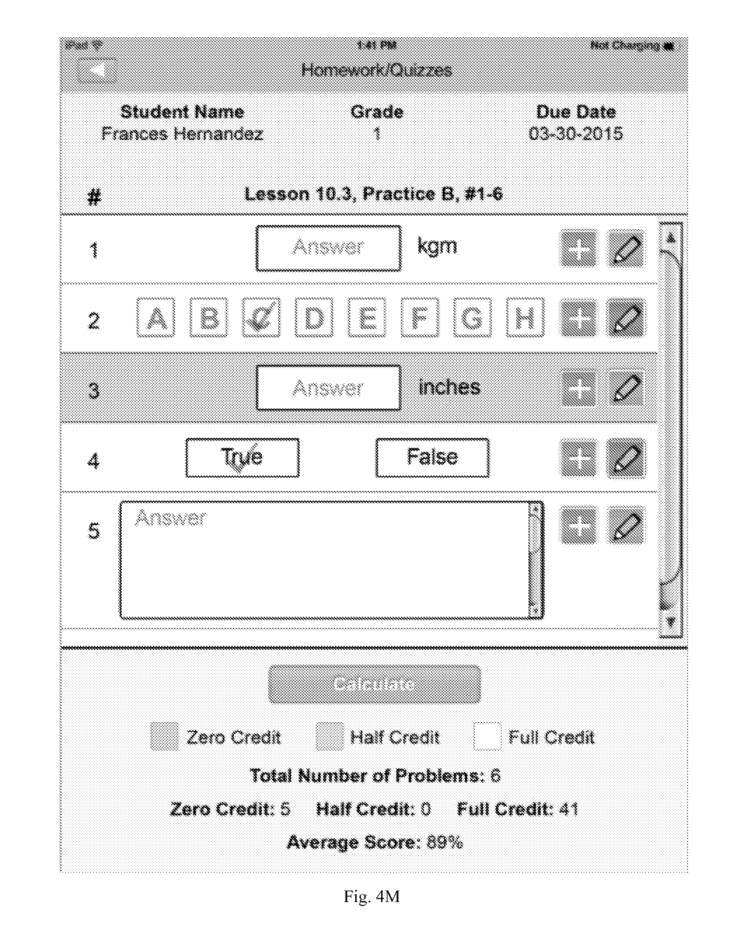

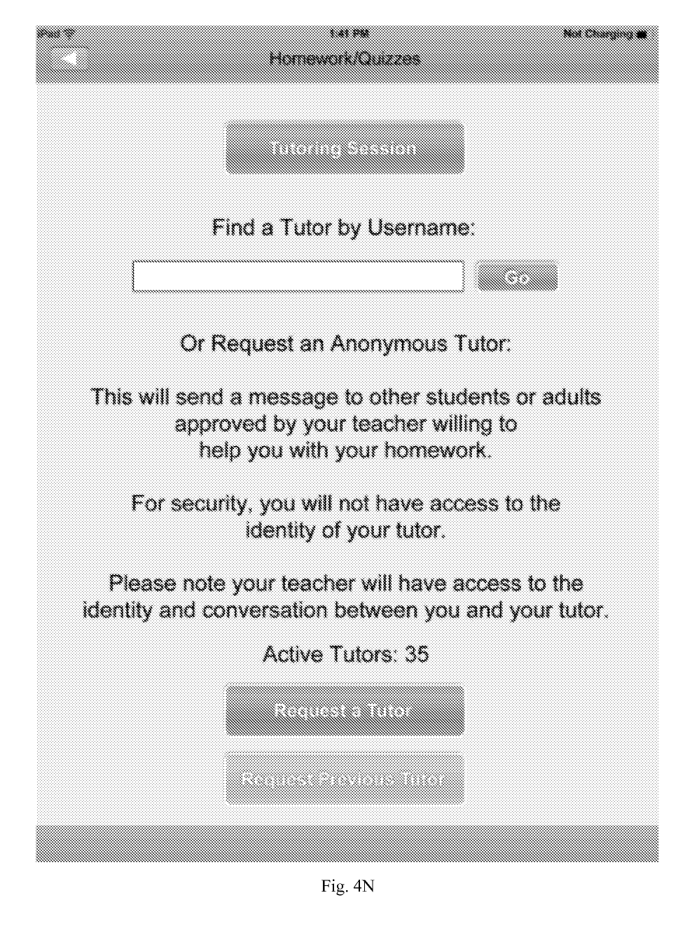

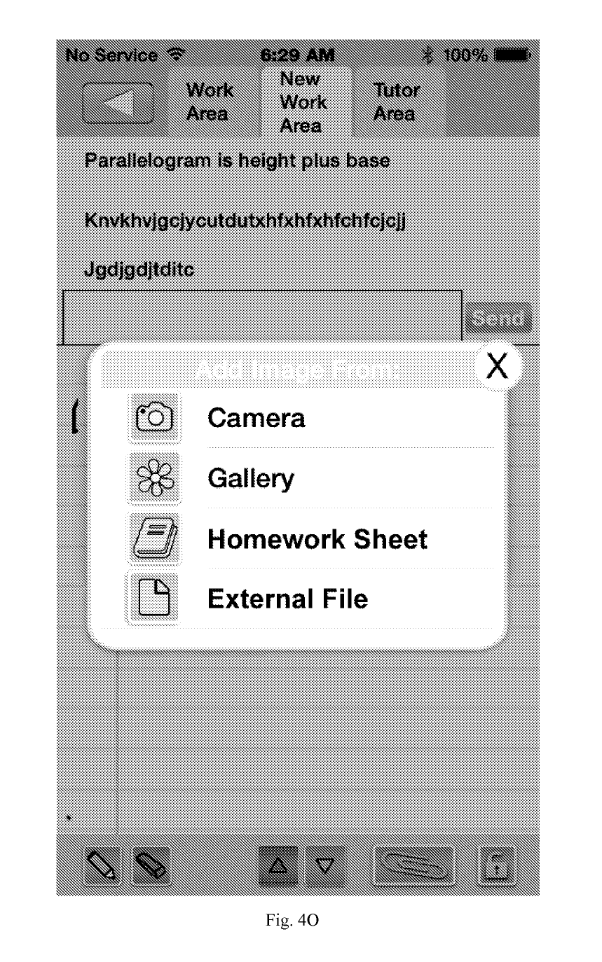

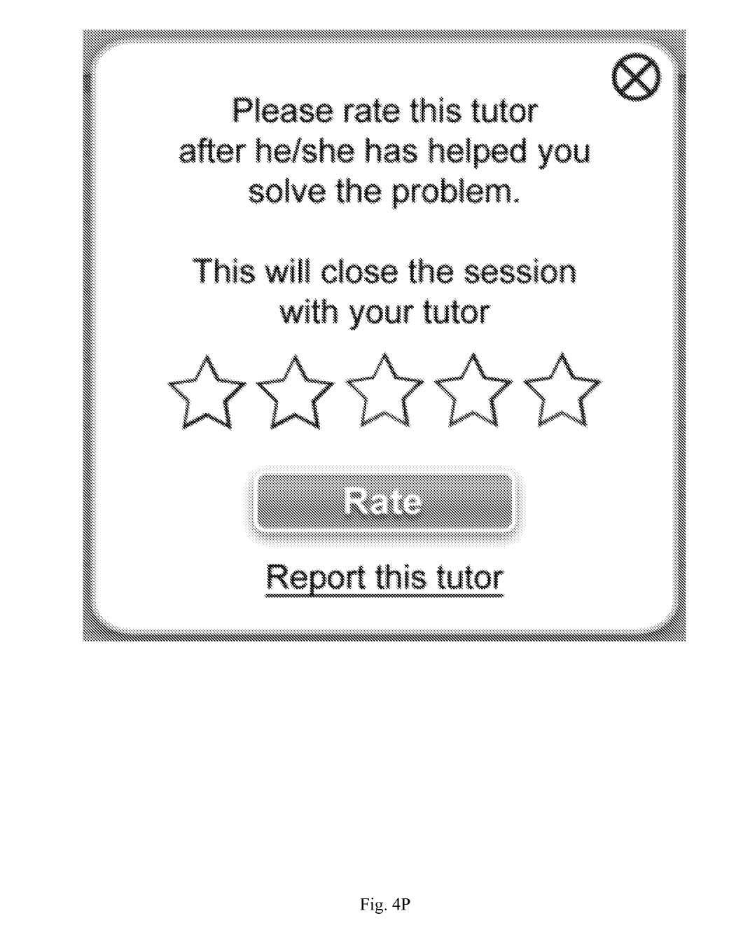

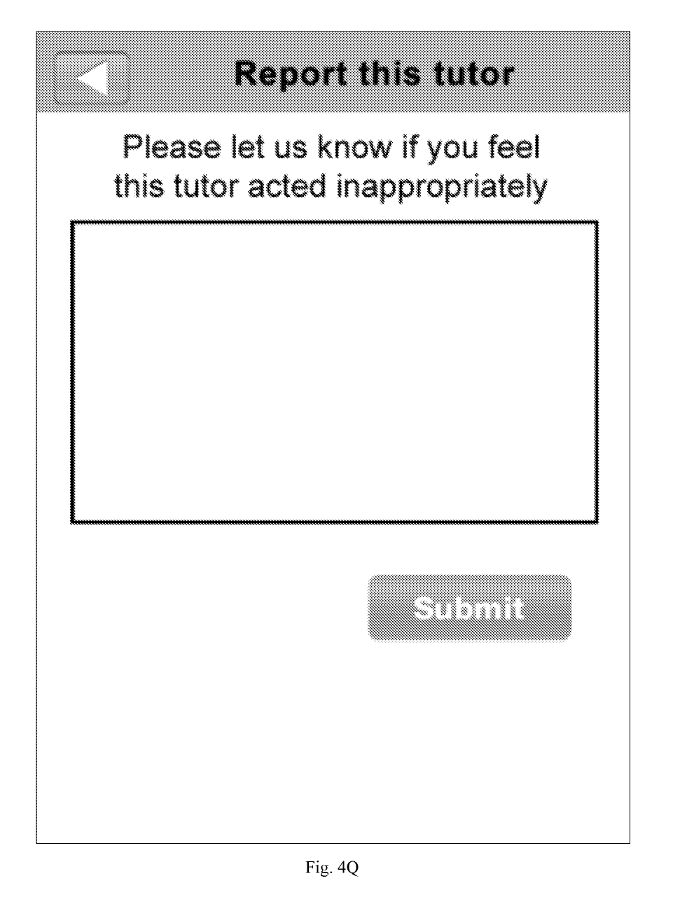

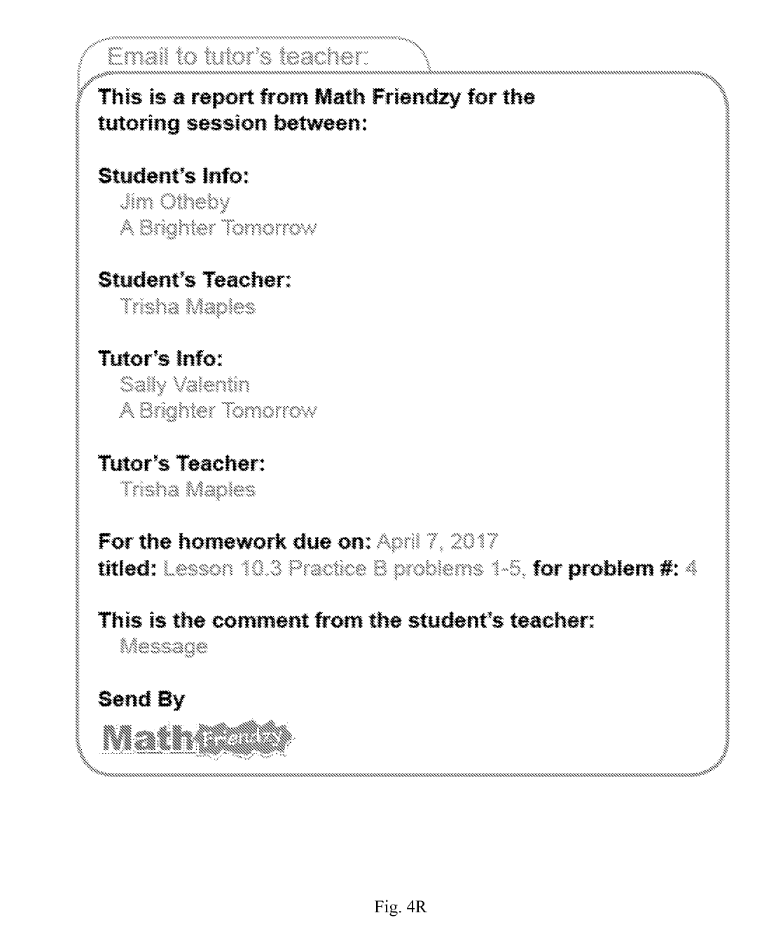

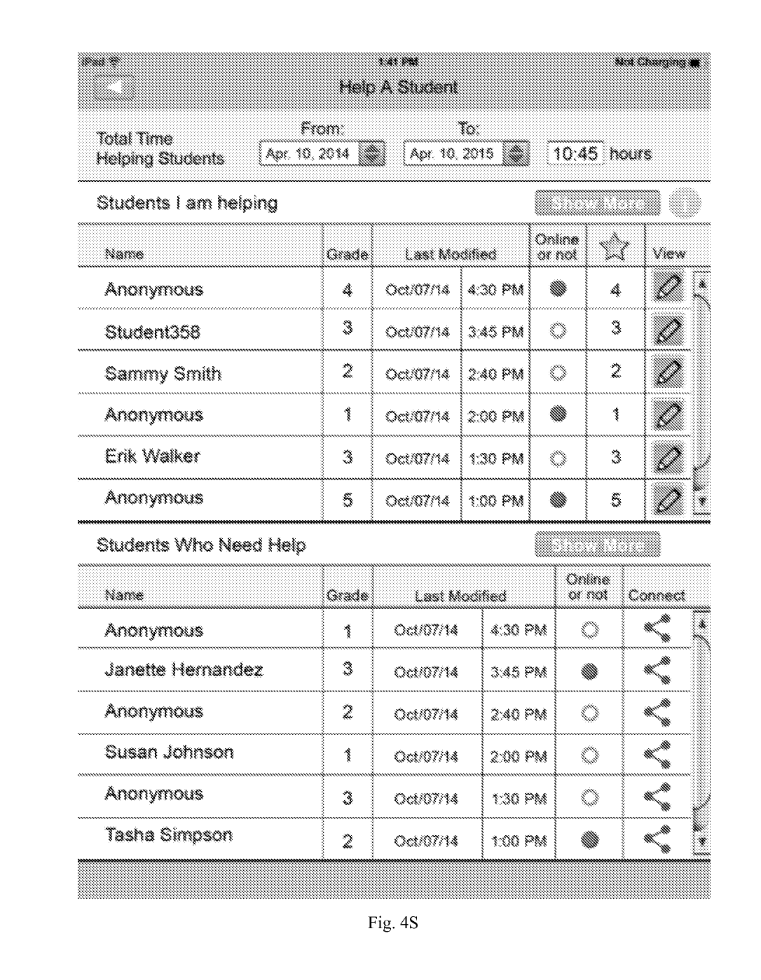

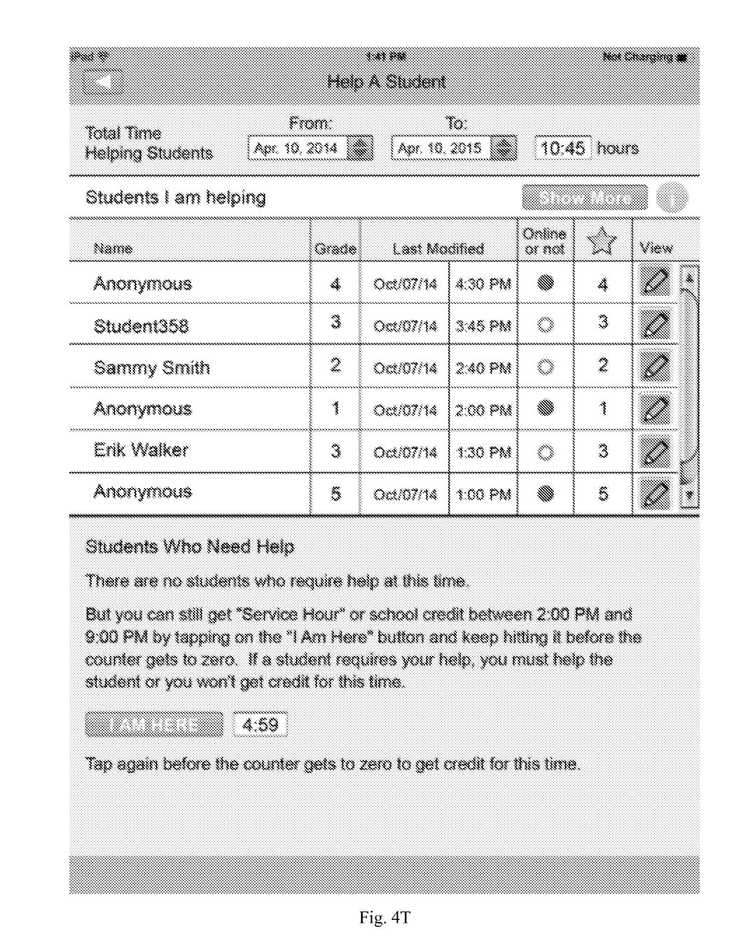

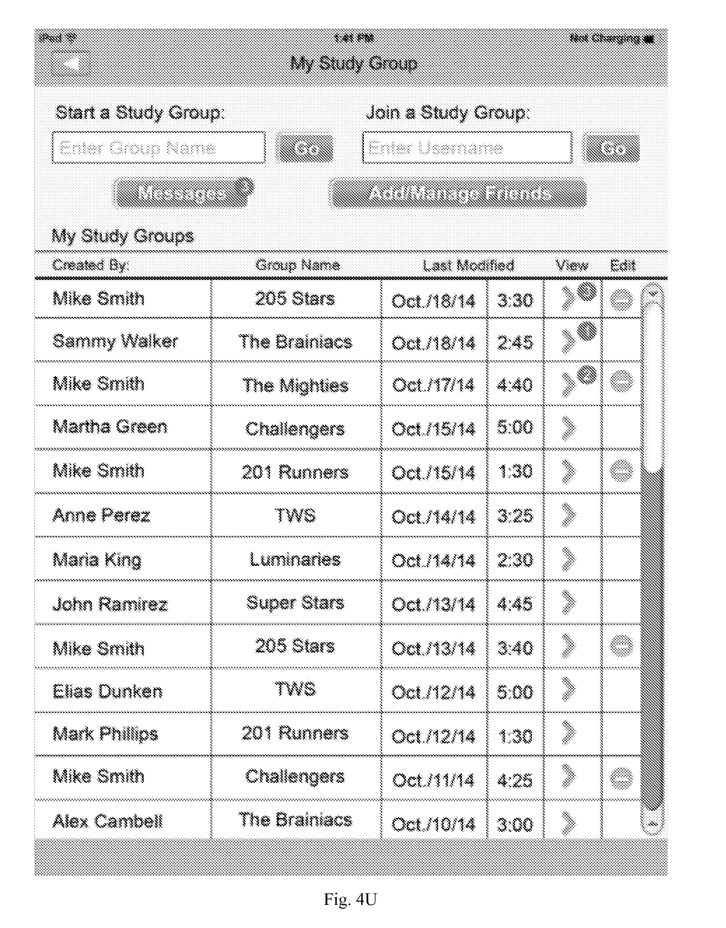

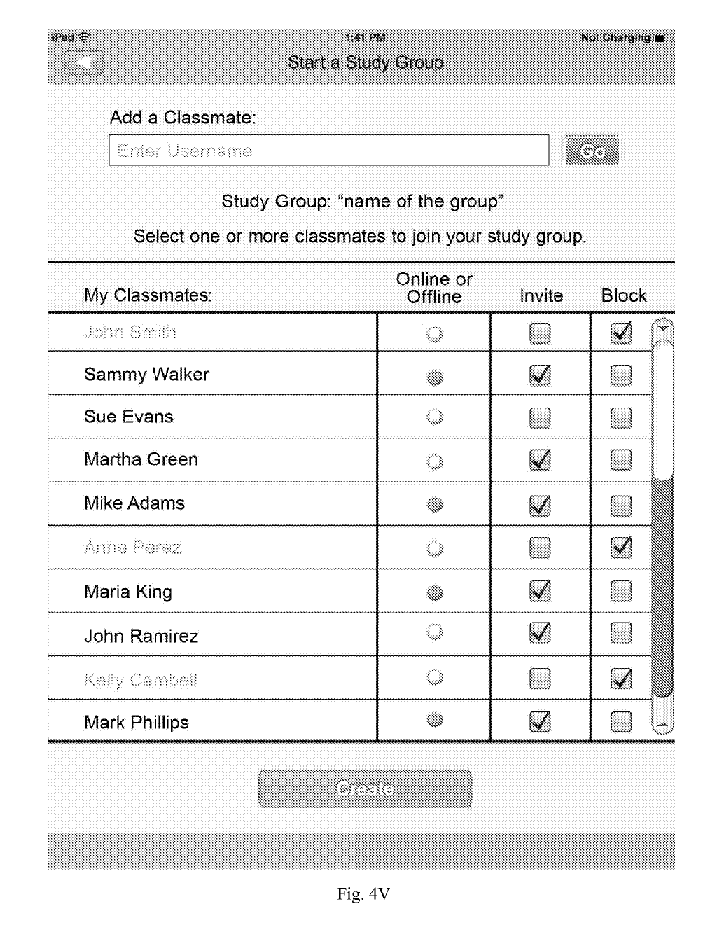

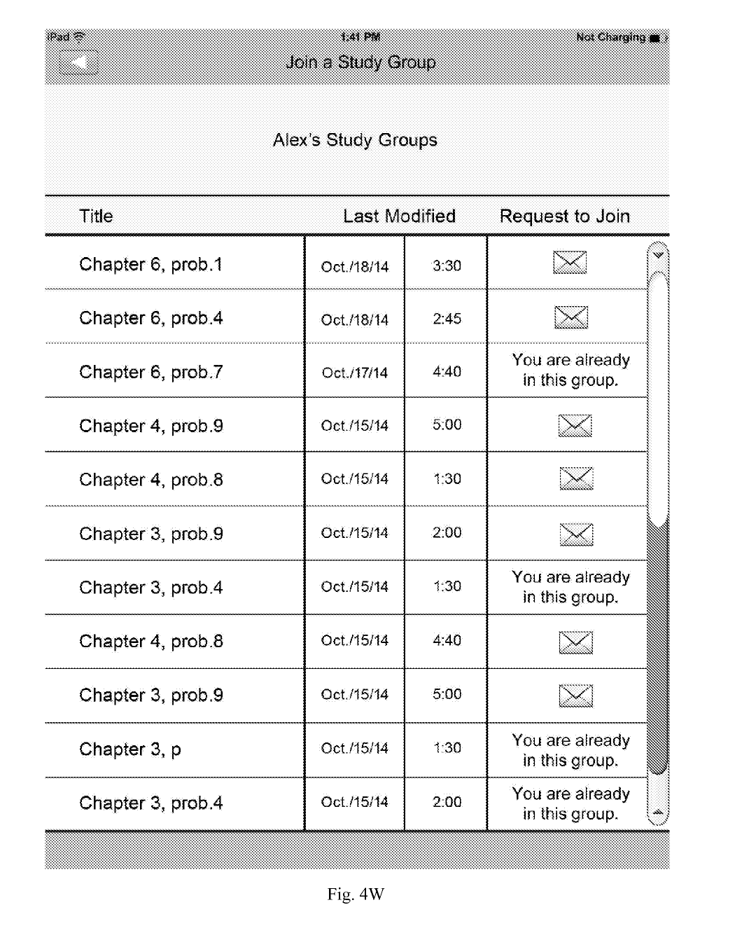

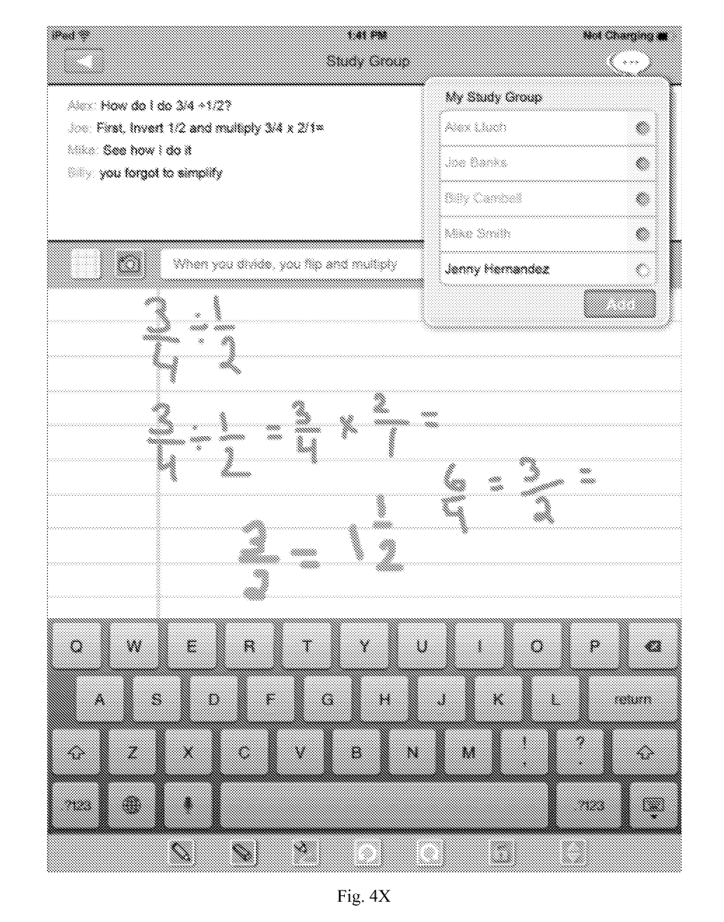

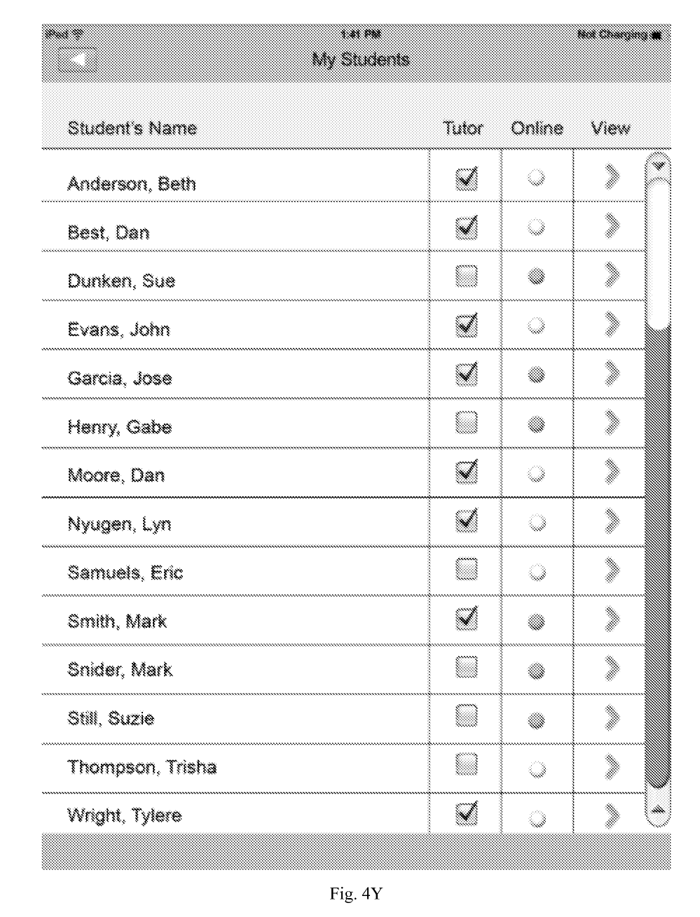

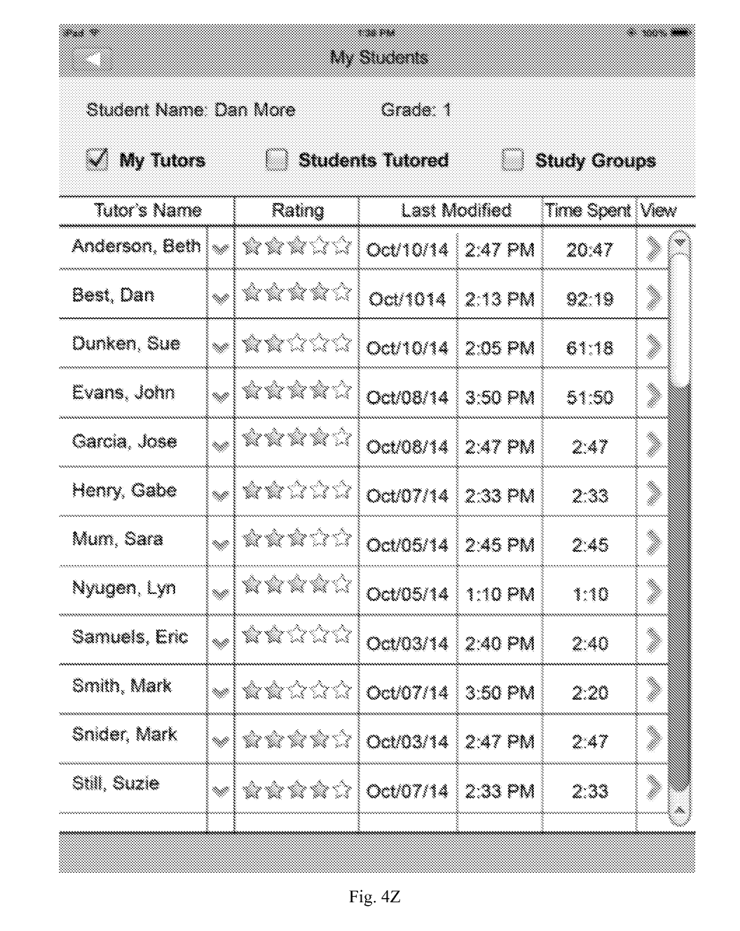

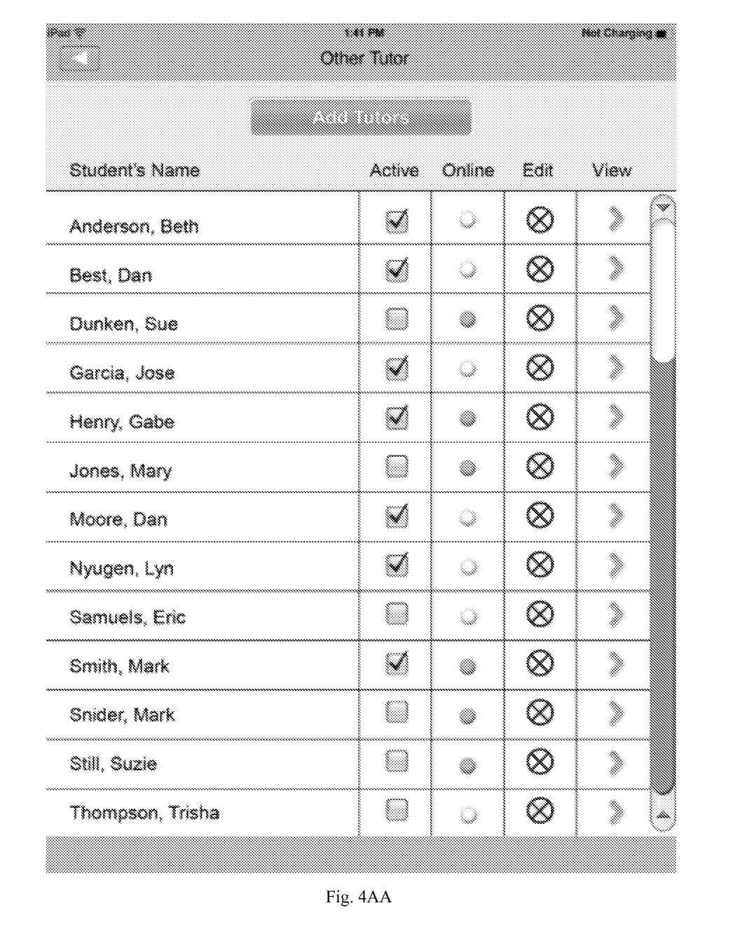

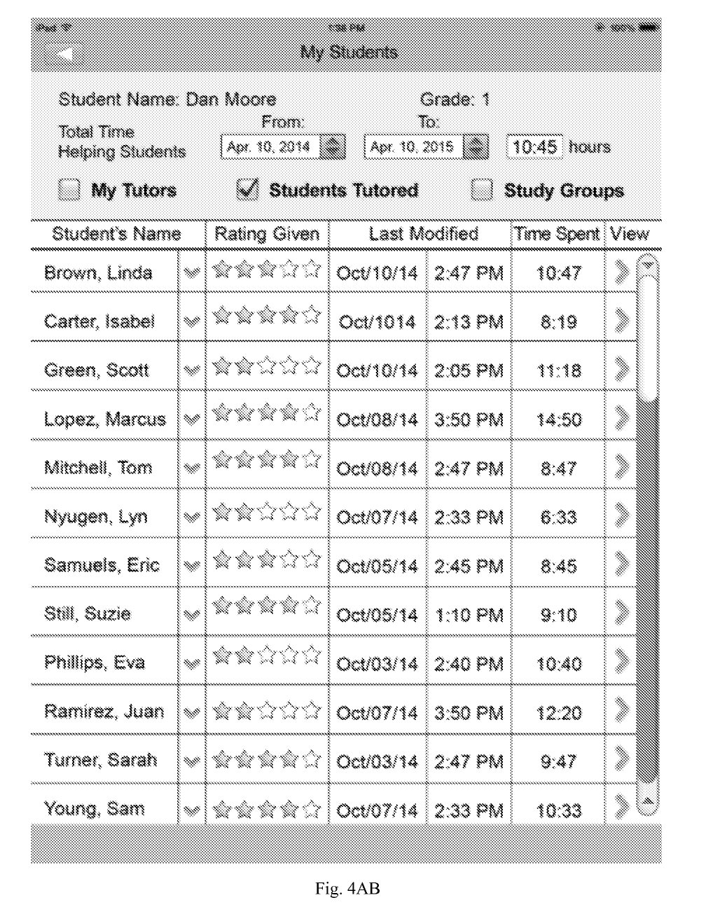

The student application 118 accesses an education program problem set screen 122, selects problems from the problem set screen, and optionally accesses collaborative learning resources 124 associated with the selected problems. Detailed examples of a problem set screen are provided below (see FIG. 4D). Some examples of collaborative learning resources 124 include example work sheets and anonymous tutoring. The student application 118 submits a corrected problem answer subsequent to accessing an associated collaborative learning resource 124. The student application 118, or a student identity associated with the student application, may receive partial credit for any correct problem answers submitted as a result of accessing a collaborative learning resource, which may discourage too frequent use and over reliance. However, the available of easy to access online resources may also be seen as an overall student motivation mechanism. It is believed that the combination of accessing remote collaborative learning resources and the grant of partial credit are an education feature that heretofore was unavailable to students. As explained in detail below, some of the major functions of the education program 108 are to permit student computing devices access to problem sets, access to collaborative learning resources, to accept problem answers, and monitor the use of collaborative learning resources. The system can offer a number of points or coins for each homework problem the student attempts or gets correct. These points and coins can be used by the students to play embedded or external games included with the system.

The student computing device (computer) 112, as well as the other computers described herein, may employ a bus 130 for communicating information between the processor 114, the memory 116, the network interface 132, and an input/output (IO) interface 134. The computers described herein may also include a main memory, such as a random access memory (RAM) or other dynamic storage device, coupled to the bus for storing information and instructions to be executed by processor. These memories may also be referred to as a computer-readable medium. Alternately, some of these functions may be performed in hardware. The practical implementation of such a computer system would be well known to one with skill in the art. The student computing device may be a desktop computer, such as a personal computer (PC), Mac computer, workstation, server, or a handheld device. Some examples of handheld devices include a personal digital assistant (PDA), cell phone, smart phone, tablet, or notebook computer.

As used herein, the term “computer-readable medium” refers to any medium that participates in providing instructions to a processor for execution. Such a medium may take many forms, including but not limited to, non-volatile media, volatile media, and transmission media. Non-volatile media includes, for example, optical or magnetic disks. Volatile media includes dynamic memory. Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, or any other medium from which a computer can read. The student, tutor, education, and teacher applications described herein may be embedded in any of the above-mentioned mediums.

The IO interface 134 may be connected to a variety of user interface (UI) peripheral devices, such as a keyboard, mouse, touchscreen, stylus, display, or voice command module, to name a few common examples. For simplicity, only a keyboard 136 and display 138 are shown. These UI devices permit the student application to accept commands from, and present information to a student user. The links to the UI peripherals may be wired connections or use wireless communications.

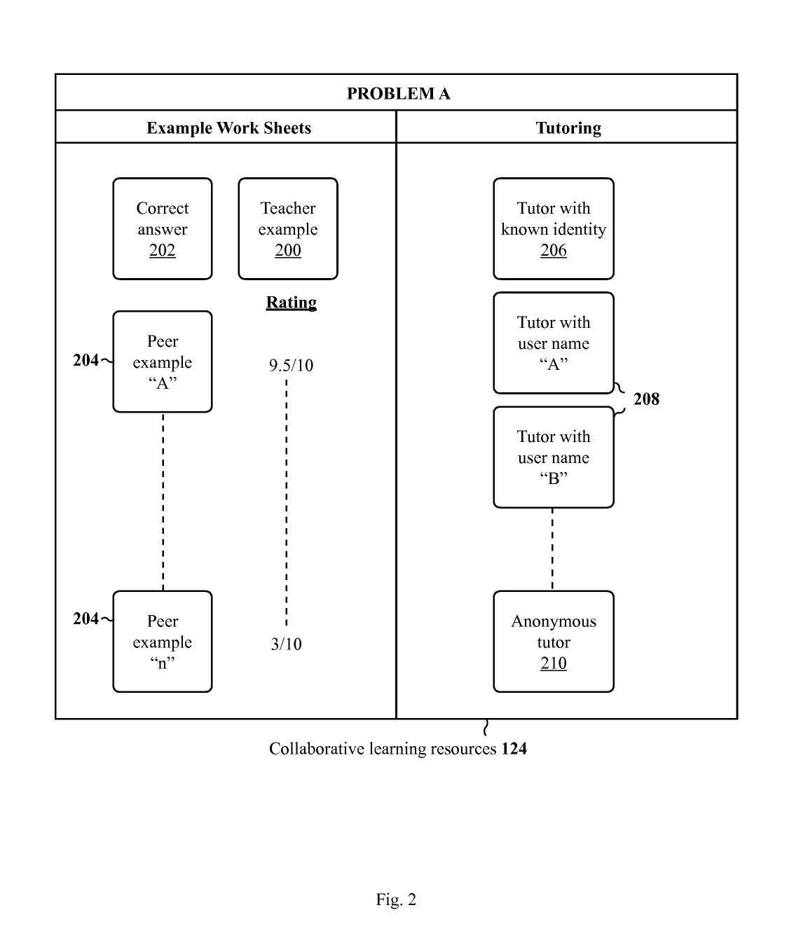

FIG. 2 is a diagram representing an exemplary collaborative learning resources (CLR) center. Typically, the student application accesses a collaborative learning resource 124 after an incorrect correct answer has been submitted. However, a collaborative learning resource 124 may also be accessed when a student does not know how to begin a problem, or to discover alternative or simpler solution methods. In one aspect, the student application accesses a first collaborative learning resource 124 exclusively associated with only a first problem (e.g., problem “A”). That is, each problem in the assigned problem set is associated with one or more CLRs dedicated to just that problem. Thus, each problem has its own CLR center of example work sheets and tutoring access. In the case of example work sheets, there may be a single work sheet 200 created or approved by a teacher, which may include hints and suggestion, or a work sheet 202 that simply supplies the correct method of solution. Alternatively or in addition, there may be a number of peer example work sheets 204 created by classmates or other students (e.g., students from a higher grade or students from a different school). In the case of peer example work sheets, the student application 118 may optionally be able to supply a quality rating to any example work sheets they access. In one aspect as shown, the student application 118 is able to access a table of peer example work sheets associated with a particular problem, cross-referenced by a quality rating, which permits the selection of the most preferred (i.e., “best”) example. An example work sheet is an electronic file including text or drawings. For example, the example work sheet may be in a portable document file (pdf) or Word, Excel, Google Docs, PowerPoint, or similar format. Alternatively, the example work sheet may be a cartoon or animated file, video, verbal lecture, or a combination of these types of presentations.

Returning the FIG. 1B, in one aspect the student application 118 may submit a tutor request to the education program 108. The education program 108 anonymously links the tutor request to the student application 118, and lists the tutor request on a tutoring billboard 126. A tutor computing device 140 comprises a processor 142, a non-transitory memory 144 embedded with a tutoring application 146 enabled as a sequence of processor executable instructions, and a network interface 148 connected to the education server 102 on line 120. As with the student computing device 112, the tutor computing device 140 typically has an IO port 150 connected to UI peripherals 152 as described above. Although only one tutoring computer device is shown, the system 100 is not limited to any particular number of connected tutor computing devices. As shown in FIG. 2, the student application is optionally able to select from different types of tutoring resources. It should be understood that significant modifications are required to convention protocols to enable the tutor application and student application to remain anonymous from each other. The education program is responsible for maintaining anonymity while simultaneously enabling connectivity.

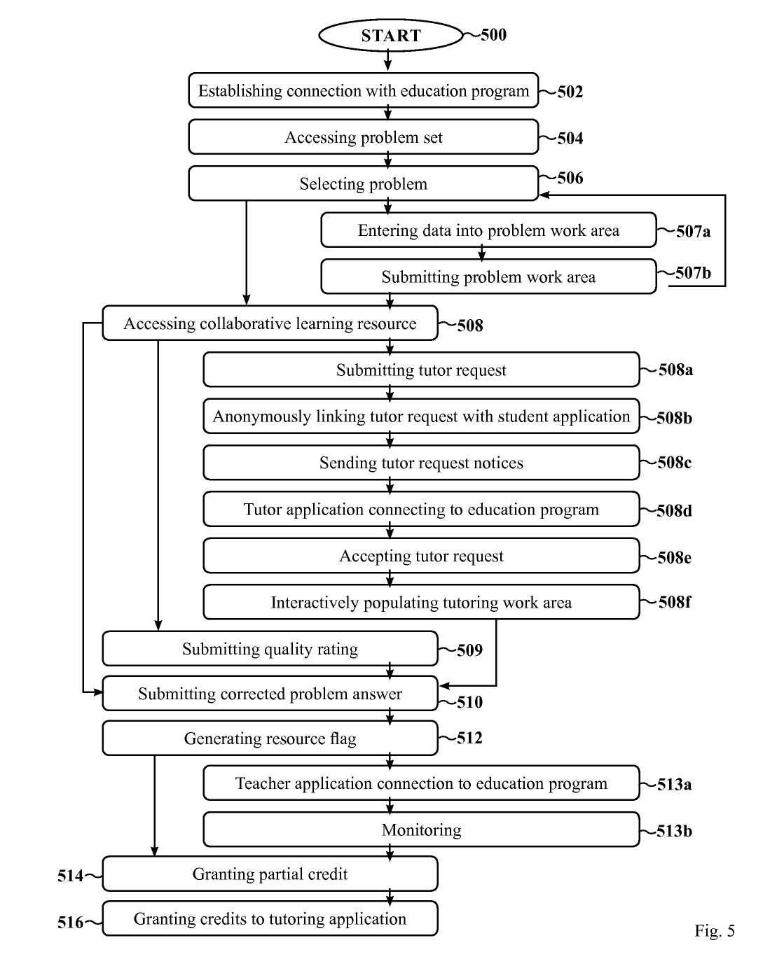

Returning to FIG. 2, in one aspect a tutor 206 user name associated with a known identity (e.g., a teacher) may be selected. Alternatively, a tutor 208 with a known user name, but unknown user identity, may be selected. Perhaps such a tutor user name is selected on the basis of a previous successful tutoring experience. Advantageous, the system described herein permits the use of an anonymous tutor 210. As explained in more detail below, the anonymous tutors may be students, community volunteers, or paid professionals. Alternatively, as described in the explanation of FIG. 5, the system may send tutor requests to a plurality of tutoring applications, with one of the tutoring applications accepting the tutoring request. When an anonymous tutor is used, the system may provide the student application with a user name for future reference by the student application, or the tutoring application may be supplied without any user name, anonymous or otherwise. In one aspect, the tutoring application accesses the education program and either it, or an associated user identity, automatically becomes certified to communicate with student applications in response to successfully passing a qualification test. The qualification test may be general for all subjects, or certification may be granted on a subject-by-subject basis.

Either the education program or a teacher application is able to monitor interactions between the student application and the tutor application, either asynchronously or in real-time. In one aspect the system it is able to keep track of the time a tutor spends helping students, and optionally grant a tutoring reward to the tutor application, or to a user identity associated with the tutoring application. This reward may be school credit, financial, or community service hours, based upon tutoring productivity, tutoring quality, or tutoring availability.

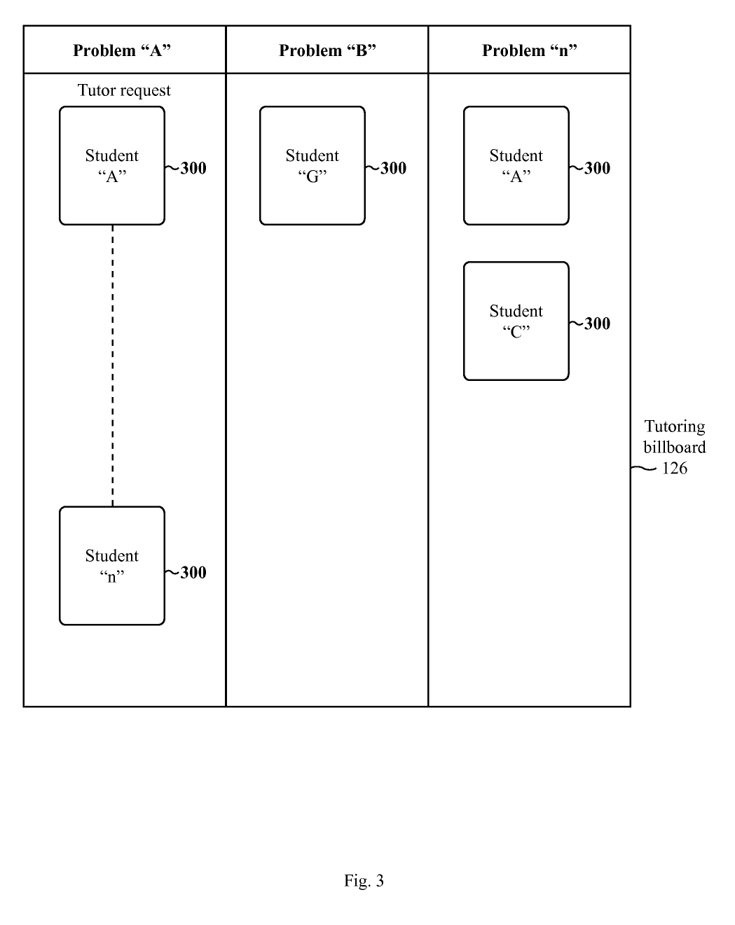

FIG. 3 is a diagram representing a tutoring billboard. In this aspect, the tutoring application 146 is able to access the tutoring billboard 126, select a tutor request 300, and thereafter interactively populate a tutoring work area screen. Advantageously, the system described herein enables the tutoring work area screen to be anonymously transceived with the student application via the education program. For example, the tutoring work area screen may be an electronic file maintained in the education server memory into which the student application and tutoring application are able to access, populate, make comments, modify, and generally communicate information. As already mentioned above, the file formats may be pdf, Word, Excel, Google Does, PowerPoint, or the like As used herein, “transceive” means to both transmit and receive information back and forth. Alternatively, the tutoring work screen area may be an electronic file that is sent back and forth between the student computing device and the tutor computing device. Examples of tutoring work area screens are provided below. In one aspect, once the tutor request is accepted, the student computing device and tutor computing device may communicate directly without the education server acting as an intermediary. However, when anonymous tutoring is requested, the education server can advantageously act as a security firewall preventing the communicating devices from exchanging user identities, user names, and Internet Protocol (IP) addresses.

In one example, the student application 118 makes a request to the education server 102 that a tutor CLR is desired. The server 102 sends out a notification via a script on the server notifying tutor applications. When a tutoring application 146 joins the tutor session, a session ID is created when the tutoring application and student application 118 are connected. When either the student application 118 or tutoring application adds input to the tutoring work area screen, a python file on the server 102 takes the coordinates of the tutoring work area screen and then stores it in a specific table on the database 106. The receiving application then reads from that table via the session ID.

As can be seen in the figure, each tutor request 300 is associated with a particular problem. This permits a tutor to select the problems with which they are most familiar, most comfortable, or for which they have been certified. That is, the student application selects a particular problem (e.g., problem “A”) from the problem set, and submits a tutor request 300 to the education program for problem “A”. Thus, the tutoring application is able to select a tutoring request advertised as being associated with problem “A”. As a result, a student application (e.g. student “A”) requesting help for problem “A” and problem n, may receive help from two different tutoring applications.

Returning to FIG. 1, in some aspects of the system, depending on the field and depth of study, the student application 118 may access a first problem work area screen associated with the first problem prior to accessing a collaborative learning resource. That is, each problem may be associated with work area screen (e.g., an electronic file or document) that is submitted with the answer, or is submitted as part of the answer (e.g., the steps taken to solve the problem). Examples of problem work area screens are provided below, see FIG. 4I. Thus, the student application is able to enter data in the form of images, drawings, text, audio files, video, etc., into the problem work area screen, and submit the problem work area screen with its associated problem answer. The work area may include files in popular formats such as pdf, Word, PowerPoint, Excel, Google Does, etc. The files can also be included in the tutor area so the tutor/teacher can review or correct documents in other computer formats. Teachers have access to the original files, the file corrected by the tutor, and the file corrected by the student after being reviewed by the tutor. In one aspect, the tutoring session may be initiated by the student application cutting-and-pasting an incorrect problem work area screen into the tutoring work area screen as a means of initiating the session. After the student copies the original work area into the remedial or tutoring work area screen, “undo” and redo” buttons may be used to undo steps performed in the original work area, so that the correction-tutoring can be started. If the problem answer was initially incorrect and a tutor CLR was accessed, the education application may accept and review a remedial work area screen submitted by the student application.

In another aspect, the education program 108 freezes the problem work area screen for a particular problem when the student application 118 accesses a collaborative learning resource 124 associated with that problem. Accessing a CLR causes the system to set a flag, indicating that a particular student has sought help for a particular problem. Setting the flag prevents the problem work area screen from being covertly corrected. The frozen work area screen can be compared to the remedial work area screen or with the tutoring work area screen.

Another advantage of the system is that the tutoring application 146 may transceive the tutoring work area screen 154 with the student application 118 in real-time, or asynchronously. The communications are asynchronous in that responses may be delayed. For example, a tutor request may be selected by the tutoring application without the student application being online (connected to the education program). The student application 118 may populate a portion of the tutoring work area screen 154 without the tutoring application 146 being online, and likewise, the tutoring application may populate a portion of the tutoring work area screen without the student application being online.

In another aspect, the system 100 further comprises a teacher computing device 156 with a processor 158, a non-transitory memory 160 including an embedded teacher application 162 enabled as a sequence of processor executable instructions, and a network interface 164 connected to the education server 102 on line 120. As with the student computing device 112, the teacher computing device 156 typically has an IO port 166 connected to UI peripherals 168. Although only one teacher computer device is shown, the system 100 is not limited to any particular number of connected teacher computing devices. The teacher application 162 is typically able to access frozen problem work area screens, the tutoring work area screen associated with particular problems, the remedial work area screen associated with particular problems, any files attached to or associated with problem work area, (optionally) the user identity associated with a tutor application, and the user identity associated with a student application. The teacher application 162 may also grant partial, full, or extra credit in response to corrected problem answers, where a CLR was accessed, or certify user identities associated with tutor applications.

Either the teacher application or the education program may grant a tutoring application access to the system. A test may enable potentially any user, even a student, to become certified as a “Tutor” for a specific course (e.g., calculus). So in this case, if a student passes the certification test, the system may allow that student to become a tutor for calculus automatically without a teacher or administrator having to grade the test or recognize the student as a tutor. The system may even qualify the tutor by conducting an automatic criminal background investigation in order to ensure the safety of the students.

Typically in the course of a homework session, the student application 118 selects a plurality of problems from the problem set screen 122. The answers submitted to these problems may be correct, corrected after accessing a CLR, or incorrect. In one aspect, the education program 108 creates an answer screen 170 associated with student application. The answer screen distinguishes a first plurality of correct answers submitted without accessing a collaborative learning resource, a second plurality of correct problem answers submitted in response to accessing a collaborative leaning resource, and a third plurality of incorrect problem answers. For example, the answer may be distinguished by color, font, or background to name a few examples. As noted above, the education program 108 (or teacher application 162) may grant the student application 118 partial credit for the second plurality of correct problem answers. Detailed examples of answer screens are provided below.

FIGS. 4A through 4AB are diagrams representing an exemplary student application graphical user interface (GUI). The GUI allows teachers to assign homework and quizzes to students, and allows students to access tutors and create study groups. The functionality described in this explanation is that of a touchscreen device, but it can be used to describe desktop computer functionality as well, for example, by replacing the function of “tapping” with “clicking” or “selecting”. Initially, the student selects the “School Functions” button (FIG. 4A). Teachers access their features by tapping on the “Teachers' Functions” icon in the lower right-hand corner of the homepage screen. In FIG. 4B there is a circle with the number 1 in it, indicating that the student who is signed in currently has 1 active homework assignment, which can be accessed by tapping on the “School Functions” button and then the “Homework/Quizzes” button.

When the student taps on the “Homework/Quizzes” button, the screen of FIG. 4C is shown containing the student's assignments from the teacher, both active and past. Past assignments are highlighted. The screen is titled “Homework/Quizzes” and contains the teacher's name, the student's grade, the due date, and the composition of the homework. The student receives a push notification when the teacher assigns each homework assignment. As the student completes the homework, the percentages under each component update. Homework can be composed of Practice Skills, Word Problems, and Class Work/Quizzes. The Average Score is calculated by taking the total number of problems the student got right in all three categories and dividing that by the total number of problems assigned to the student in all three categories. There is an arrow button at the end of each row, and tapping on it takes the student to the homework assignment page.

On the student's homework assignment page (FIG. 4D), every component assigned to the student for that homework assignment is displayed. At the top, the teacher's name, the student's grade, and the assignment's due date are displayed. Beneath that, there is a space where a message from the teacher can appear. Beneath that, the homework categories and subcategories are displayed. For each portion of the assignment, the number of questions and the student's score is provided. Tapping on the arrow at the end of each row takes the student to the page (problem answer sheet) to complete that portion of the assignment. At the bottom of the page are displays of: the total number of problems, how many items received zero credit, how many items received partial credit, how many items received full credit, and the student's average score. These totals update as the student completes each portion of the homework assignment.

When the student taps on a “Practice Skills” portion of a homework assignment, the student is taken to the set of practice problems assigned by the teacher (FIG. 4E). The student can complete the assignment by tapping the buttons on the keyboard.

When the student taps on a “Word Problems” portion of a homework assignment, the student is taken to the set of word problems assigned by the teacher (FIG. 4F). The student can complete the assignment by tapping the buttons on the keyboard.

When the student taps on an assignment under “Class Work/Quizzes”, an assignment custom designed by the teacher appears (FIG. 4G). The student is able to enter answers. The question types might be single answer, multiple choice, true/false, yes/no, or open ended. When the student is done answering, they can tap on the calculate button at the bottom of the page to receive a grade. The fields at the bottom of the page (Zero Credit, Half Credit, Full Credit, and Average Score) update automatically. Wrong answers are highlighted (e.g., will appear in red). If the teacher has allowed changes, the student is able to make changes to the homework and submit again. If the teacher has allowed students to change their answers after getting it wrong and to see the correct answer, then students can view the correct answers or access other CLRs associated with the incorrect problems by tapping on the “+” button.

When the student taps on the “+” button (FIG. 4H), the student sees four options: “See Correct answer”, “Teacher's Explanation”, “See how Others Did it”, and “Connect with a Tutor”. Any of these options typically gives only partial credit to the student to discourage the student to use any of these help features. Tapping on the “See the Correct Answer” button shows the student the correct answer, and the student can revise and resubmit for partial credit. A unique feature is that the student must show their work on a “Work Area” created for each problem. The student must try to solve each problem before having access to any of these four features. If the student uses any of these four features, the original work area is locked so the user is not be able to make any changes to that work area, and a second work area is created for that problem. The purpose is to give the teacher access to the student's original work before the student received help from the system. The student can tap “Teacher's Explanation” to see the teacher's explanation to solving the problem, or “See How Others Did It” to see how other classmates have already answered that problem correctly. These explanations may be in the form of text, drawings, audio, video, etc. The student can also tap “Connect with a Tutor” to receive assistance from a live tutor.

When the student taps “See How Others Did It,” a new screen appears listing all the classmates who have gotten that question right. Students can see the rating that other students have given to the explanation given by each student. The student can then tap on the name of a student to view that student's Work Area and learn how to solve the problem (FIG. 4I). The student can then rate their classmate's explanation of that problem. This motivates students to put much more effort when answering their own homework. The students are able to rank their classmates explanation with a rating (e.g., 1 to 5 stars) showing how effective their peers thought that Work Area was.

When the student taps on “Work Area”, either from the “View Correct Answer” screen or from the icon on the answer sheet after viewing how other classmates solved the problem, the work area for the student now has two tabs, “Work Area” and “New Work Area”. The original work area shows the original work that the student did before getting help. The new (remedial) work area allows the student to show their work after getting help. The original work area, new work area, and tutor work area may have the pencil, erase, and scroll options on the bottom for the student to explain their work via text or drawing. The student can also add a section of the “Homework Sheet(s)” provided by teacher so the student can put an image of the specific problem on the work area, or add any other image using the device's camera, gallery, or add audio or video files. This area may also have “undo” and “redo” buttons to allow students to erase portion of their work quickly. Students can also attach files to this work areas in popular formats such as PowerPoint, pdf. Word, Excel, Google Docs, etc. There is a lock icon to allow the student to make the work area private. This is in case the student doesn't want other students to view their explanation, see FIG. 4J.

If the student comes to the work area after viewing “Correct Answer”, “Teacher's Explanation”, “See How Others Did It”, or “Connect with Tutor”, see FIG. 4H, the original work area is frozen and a second work area tab appears for the student to complete the problem, showing how the student completes the problem after getting help from the system. The teacher can then compare the two work area tabs if desired.

If the teacher has included a homework sheet, the student can tap on “View Homework Sheet(s)” (see FIG. 4J) to view it. The student can then choose to copy a portion of the answer sheet and paste it in the work area to show which problem the student is working. Students can also paste a photograph of their own, such as graph paper or the picture of an image or illustration, and then crop or resize the photograph and draw over it. This can be a photo or scan of the problem answered on a piece of paper (FIG. 4J). Students can also attach external files in a number of conventional formats.

If the student accesses any CLRs by using any of the above-mentioned options, and they enter the correct answers on the answer sheet and tap “Calculate again”, the system highlights that answer indicating that the student got partial credit (FIG. 4G) for accessing the CLRs. The highlighting prompts the teacher to view the work areas of the student for that specific problem to see if the student showed their work or simply copied the correct answer. The student's score updates accordingly.

If the teacher provides feedback to the student in the work area, the arrow for that homework assignment changes, indicating input from the teacher. (FIG. 4K). The student can tap on that assignment and see which problem of the assignment has feedback from the teacher. Then the student can tap on that component and see which work areas have feedback (FIG. 4L). The highlighting of the work area icon changes when the teacher has provided feedback (FIG. 4M).

In FIG. 4H, when a student taps on “Connect with a Tutor,” the student is taken to a new work area in which a tutor approved by the teacher is able to join, to help the student with their problem. The student can select to request an anonymous tutor or request a tutor by username (FIG. 4N). Anonymity is effective because tutors cannot give preferential treatment to a certain categories of students, and students are less afraid to ask stupid questions to classmates. After the student taps on “Request a tutor”, the student is prompted to enter the problem and wait for the tutor to join. If the request is anonymous, a notification is sent to all of the approved tutors in the school, or to one or more nearby schools with approved students or teacher tutors, or qualified members of the community. Alternatively, interested tutors may access a billboard of tutor requests. The first tutor to accept the notification is sent to the “Tutor Work Area” to begin helping the student. At this point, the student is removed from the list of students on all other tutor dashboards. The student's screen indicates that the tutor has accepted. The tutoring session is anonymous and can be conducted live or asynchronously. When a tutor access the Tutor Work Area, if they feel unqualified to answer the question, they are able to reject the question and allow another tutor to answer the question.

Both the student and the tutor can write in the work area and type in the chat window or draw in the work area (FIG. 4O). The tutor can also add an image from the device camera or gallery, audio/video files, or conventional file formals such as Word, pdf, Excel, PowerPoint, Google Does, etc. If both the tutor and the student are in the work area, an indicator shows both users that they are connected in real-time. After a first user leaves the work area, the other user sees an indication that the first user is no longer in the work area. If either the student or the tutor is not in the “Tutor Work Area” at the same time, when one does something in the work area; i.e., writes, draws, adds an image, etc., the other user receives a push notification indicating that something has added to the “Tutor Area.” This push notification tells the user the problem for which the input has been received so the user can go to that “Work Area” and see the input. At the bottom, there are buttons for “Pencil”, “Eraser”, “Undo”, “Redo”, “Marker” (which has multiple colors and sizes), and “Add Page” (to add more Work Area screens). Under the chat window, there are buttons for “Background” (to change the background to a different texture or line configuration) and “Attachment Icon” (to upload an image).

When the student and tutor connect, a Thumbs Up icon appears on the tutor tab FIG. 4O. At any time, the student can terminate the session with the tutor in the case that the student has understood the problem, or in case the tutor is not able to help the student. By tapping on the Thumbs Up icon, the student has the ability to rate the tutor via a five star rating (FIG. 4P) or “Report The Tutor” (FIG. 4Q). If the student taps on Report This Tutor (FIG. 4P), the student is able to write a note to the Tutor's teacher indicating how the tutor has acted inappropriately. This will send an email to the Tutor's teacher with the student's message. This email will indicate the student's name, school and teacher, the tutor's name, school and teacher, the specific homework problem, and the student's message, see FIG. 4R. This action disallows the tutor from making changes to the work area. After this, the student can choose to request another tutor if desired. Students can also find a tutor by username to request a tutoring session with a specific tutor. The student only receives partial credit for a problem answer after connecting with a tutor. A special keyboard allows students to type in complex mathematical formulas. If the student still needs help after consulting with the school tutors, the student can request help from a professional tutor. This may require a payment that is processed through the system, which connects the student with a professional tutor contracted by the education program.

The tutor has the same editing functions that the student has. The tutor also has the option to disconnect from a student if the tutor is incapable of helping with a particular problem. This disconnect sends a push notification to the student indicating that a tutor has disconnected for a specific homework problem. At this point, the student can go to the Tutor Area, and an indicator tells the student that the tutor has disconnected. The student can then rate the tutor, report the tutor, or request another tutor. The time the tutor spends in the tutoring session with a specific student is recorded for the teacher or education program to monitor, so tutors can earn compensation in the form of money, service hours, school credit, or community service time. If the tutor is inactive in the work area for a certain period of time, an indication appears, and the tutor no longer gets credit for that time.

Tutors have a homepage dashboard (FIG. 4S) where they can see all of the students they are currently helping in chronological order (“Students I am helping”), along with the other students who have requested but not yet received help (“Students who need help”). The student's name, grade, online status, and time last modified are listed. Tutors can tap on the pencil icon to view the work area and actively help the student. For students who still need help, tutors can tap on the connect button, and they will be taken to the work area so the tutoring session can begin. That student is then added to the tutor's list of “Students I am helping.”

Push notifications are sent to tutors who have been authorized to tutor that student every so often during a specific time frame, e.g., every 15 minutes between 3:00 pm and 9:00 pm device time. This screen (FIG. 4S) shows how much time a tutor has spent helping each of their students, and the total amount of time that the tutor has spent helping students between a range of dates. This time may earn credit for service hours, community service credit, school credit, or a financial credit.

If the tutor schedules their time to help students within a specific period of time; e.g., 2:00 pm to 3:00 pm, but goes to the tutor dashboard and determines there are no students who require help, the system can still give credit to the tutor. For this, the tutor taps on the “I AM HERE’ button, FIG. 4T, and taps it again before a countdown counter reaches zero. This process makes the tutor pay attention to their dashboard, i.e., check every five minutes, to determine if there are new students requiring help. This method encourages tutors to access the system and be ready to help students, as they get credit whether there are students logged in or not.

Students are able to form study groups to hold study sessions. They do this through the “Start a Study Group” feature (FIG. 4U). Students can add classmates to their accounts (FIG. 4V), and then select the classmates they would like to invite to a study session by checking the “Invite” boxes and tapping “Create.” Classmates' online or offline status is identified. If a student needs to block another student for any reason, they can tap the check box under “Block” to disallow that student from accessing their study groups.

Students can see all of the study sessions hosted by another user on the “Join a Study Group” page (FIG. 4W), accessed by searching for the other user's username. This page lists the name of the study session, the date and time last modified, and a request to join (or an indication that the student is already in the group). Students can tap on the envelope to send a request to the host to join the study session. The host receives a push notification asking them to accept the request. The study session has a work area screen similar to that of FIG. 4J. The participants' comments in the chat window and drawings on the screen may be color coded (FIG. 4X) or otherwise marked to indicate which of the students participating on the study group wrote the text or drew the drawing.

A dashboard permits teachers to qualify selected students as tutors (FIG. 4Y). An administrative dashboard allows for two schools to be connected and share tutors. This feature can be used to have middle school students, for example, tutor students from an elementary school, or a high school to tutor a middle school. In this case, the students approved to tutor at the middle school also receive anonymous tutor requests from the students at the elementary school.

If the teacher taps on “View” for a particular student in FIG. 4Y, a screen appears (FIG. 4Z) showing all of the tutoring sessions that student has participated in, along with the rating given, the date last modified, and the time spent. The teacher can choose to view any of these tutoring sessions (e.g., conversations between the student and teacher) and can also tap on the arrow next to the tutor's name to contact the tutor's teacher to alert them of any issue with this tutor. The teacher has access to identities of the student and tutor.

If the teacher taps on the “Students Tutored” box, all of the students that the selected tutor has tutored appear, along with the rating given, the date last modified, and the time spent. Again, the teacher can view the tutoring session between the student and the tutor. The teacher of the student being tutored can be alerted to any improprieties occurring between the tutor and the student.

A teacher can select a screen with a list of the tutors the teacher has approved who are not students in the teacher's class (FIG. 4AA). Teachers or administrators can add anyone as an approved tutor, such as older students from another school, parents, or community volunteers. In one aspect, only tutors certified by teachers at a given school can tutor for that school. Fields show whether the tutor is active (the teacher can uncheck this box to remove the tutor from the tutoring pool) and whether the tutor is online.

The teacher can also select a screen with a list of all the students that a particular tutor has tutored (FIG. 4AB). The teacher can see the names of the students tutored, their grades, the ratings the students gave to the tutor, the last time the session was modified, and the time the tutor spent in each session. This is important for the tutor to earn community service, school credit, financial credit, or service hours. The teacher can also view a specific tutoring session or the total amount of time that the tutor spent helping other students within a specific time frame.

FIG. 5 is a flowchart illustrating a method for using networked computer devices to provide access to remote collaborative learning resources. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. Generally however, the method follows the numeric order of the depicted steps. The method starts at Step 500.

In Step 502 a student computing device establishes a network-connection with an education server having an education program embedded in a non-transitory memory as a sequence of processor executable instructions. In Step 504 a student application, embedded in a student computing device non-transitory memory as a sequence of processor executable instructions, accesses a problem set screen in the education program. In Step 506 the student application selects a problem from the problem set screen. In Step 508 the student application accesses a remote education program collaborative learning resource associated with the selected problem. This step is typically taken in response to submitting an incorrect answer to the selected problem. Subsequent to accessing the collaborative learning resource, the student application submits a corrected problem answer to the education program in Step 510. Step 512 generates a resource flag in response to the collaborative learning resource being accessed. In response to resource flag and the submission of a correct problem answer in Step 510, partial credit is granted in Step 514 to a user identity associated with the student application. The grant may be from a teacher or the education program.

In one aspect, selecting the problem from the problem set screen in Step 506 includes selecting a first problem. Then, accessing the collaborative learning resource in Step 508 includes accessing a first collaborative learning resource exclusively associated with only a first problem. As noted in detail above, the type of collaborative learning resources that may be selected includes example work sheets, the correct answer to the selected problem, and anonymous tutoring. If a first peer example work sheet collaborative learning resource is accessed, in Step 509 the student application submits a quality rating to the education program for the peer example work sheet. In a related aspect, accessing an example work sheet collaborative learning resource in Step 508 may include accessing a table of peer example work sheets associated with the selected problem, cross-referenced by a quality rating.

In one variation, the student application accesses the anonymous tutoring collaborative learning resource in Step 508, and the following substeps are performed. In Step 508a the student application submits a tutor request to the education program. In one aspect, Step 508a submits a request associated with a tutor application user name or a previously accessed tutor application. In Step 508b the education program anonymously links the tutor request to the student application. In Step 508c the education program lists the tutor request on a tutoring billboard. In Step 508d a tutor computing device with a tutoring application, embedded in a non-transitory memory as a sequence of processor executable instructions, establishes a network connection with the education program on the education server. In Step 508e the tutoring application accesses the tutoring billboard and selects the tutor request. Alternatively, the education program sends tutoring request notices in Step 508c to a plurality of tutoring application, and receives an acceptance from one tutoring application in Step 508e.

In Step 508f the tutoring application interactively populates a tutoring work area screen, anonymously transceived with the first student application via the education program. Subsequent to finishing the tutoring work area screen, the student application submits a remedial tutoring work area screen for review in Step 510. The review may be performed at the tutoring application, a teacher application, the education program, or combinations thereof. As noted above, the tutoring work area screen can be transceived in real-time or asynchronously. In some aspects in Step 508e the tutoring application reports availability to accept tutor requests, and receives credit for being available even when no tutor requests have been submitted by a student application. This process encourages greater tutor availability.

In one aspect, in Step 506 the student application selects a first problem, and in Step 508a the student application submits a tutor request for the first problem. Then, in Step 508e the tutoring application accepts a tutoring request advertised as being associated with the first problem.

In another variation, in Step 506 the student application accesses a first problem work area screen associated with the selected first problem. Then prior to accessing a collaborative learning resource, in Step 507a the student application enters data into the first problem work area screen, and in Step 507b the first problem work area screen is submitted with the first problem answer to the education program. If the program is incorrect, then the method typically continues to Step 508. Otherwise, the method may return to Step 506 to select a new problem, or the method may finish. In one aspect, generating the resource flag in Step 512 in response to the collaborative resource being accessed additionally includes freezing the first problem work area screen.

In another variation, in Step 513a a teacher computing device with a teacher application, embedded in a non-transitory memory as a sequence of processor executable instructions, establishes a network connection with the education program on the education server. In Step 513b the teacher application may perform one or more of the following operations: accessing the frozen problem work area screen, accessing the tutoring work area screen associated with the first problem, accessing the remedial work area screen associated with the first problem, accessing a user identity associated with the tutor application, accessing a user identity associated with the student application, and certifying a user identity associated with a tutoring application. This step permits a teacher to change the partial credit automatically applied by the system based upon the effort the student has made in working the problem. Although Step 513a and 513b are shown as following Step 512, it should be understood that many of these operations may be performed before Step 512 or after Step 514.

In one aspect, in Step 513b the education program, via an administrator user, monitors the tutor application, and in Step 516 the education program grants tutoring credits to a user identity associated with the tutor application. Note: these steps may also be performed with the aid of the teacher application. The credits may be in the form of a financial reward or community service hours.

Typically, in Step 506 the student application selects a plurality of problems. Then, submitting the problem answer in Step 510 includes the education program creating an answer screen associated with student application that distinguishes the following: a first plurality of correct answers submitted without accessing a collaborative learning resource, a second plurality of correct problem answers submitted in response to accessing a collaborative leaning resource, and a third plurality of incorrect problem answers.

A system and method have been provided for accessing collaborative learning resources. Examples of particular message structures, processors, and hardware units have been presented to illustrate the invention. However, the invention is not limited to merely these examples. Other variations and embodiments of the invention will occur to those skilled in the art.

We claim:

1. A method for using networked computer devices to provide access to remote collaborative learning resources, the method comprising:
a student computing device establishing a network-connection with an education server having an education program embedded in a non-transitory memory as a sequence of processor executable instructions;
a student application, embedded in a student computing device non-transitory memory as a sequence of processor executable instructions, accessing a problem set screen in the education program;
the student application selecting a problem from the problem set screen;
the student application accessing a remote education program collaborative learning resource associated with the selected problem;
subsequent to accessing the collaborative learning resource, the student application submitting a corrected problem answer to the education program;
generating a resource flag in response to the collaborative learning resource being accessed; and,
in response to resource flag and the submission of a correct problem answer, granting partial credit to a user identity associated with the student application.

2. The method of claim 1 wherein the student application selecting the problem from the problem set screen includes selecting a first problem; and,
wherein accessing the collaborative learning resource includes accessing a first collaborative learning resource exclusively associated with only a first problem.

3. The method of claim 1 wherein the student application accessing the collaborative learning resource includes accessing a collaborative learning resource selected from a group consisting of example work sheets, the correct answer to the selected problem, or anonymous tutoring.

4. The method of claim 3 further comprising:
subsequent to accessing a first peer example work sheet collaborative learning resource associated with the selected problem, the student application submitting a quality rating to the education program for the first peer example work sheet.

5. The method of claim 4 wherein the student application accessing an example work sheet collaborative learning resource includes accessing a table of peer example work sheets associated with the selected problem, cross-referenced by a quality rating.

6. The method of claim 3 wherein the student application accessing the anonymous tutoring collaborative learning resource includes:
the student application submitting a tutor request to the education program;
the education program anonymously linking the tutor request to the student application;
the education program sending the tutor request to a plurality of tutoring applications;
a tutor computing device with a tutoring application, embedded in a non-transitory memory as a sequence of processor executable instructions, establishing a network connection with the education program on the education server;
the tutoring application accepting the tutor request;
the tutoring application interactively populating a tutoring work area screen, anonymously transceived with the first student application via the education program; and,
wherein submitting the corrected problem answer includes, subsequent to finishing the tutoring work area screen, the student application submitting to the education program, a remedial tutoring work area screen for review.

7. The method of claim 6 wherein the tutoring application anonymously transceiving the tutoring work area screen with the student application includes transceiving in a manner selected from a group consisting of asynchronously or in real-time.

8. The method of claim 6 wherein the student application selecting the problem from the problem set screen includes selecting a first problem;
wherein the student application submitting the tutor request to the education program includes the student application submitting a tutor request for the first problem; and,
wherein the tutoring application accepting the tutoring request includes the tutoring application accepting a tutoring request advertised as being associated with the first problem.

9. The method of claim 8 wherein the student application selecting the first problem from the problem set screen includes accessing a first problem work area screen associated with the first problem;
the method further comprising:
prior to selecting a collaborative learning resource, the student application entering data into the first problem work area screen; and,
submitting the first problem work area screen with a first problem answer.

10. The method of claim 9 wherein generating the resource flag in response to the collaborative resource being accessed additionally includes freezing the first problem work area screen.

11. The method of claim 10 further comprising:
a teacher computing device with a teacher application, embedded in a non-transitory memory as a sequence of processor executable instructions, establishing a network connection with the education program on the education server;
the teacher application performing a function selected from a group consisting of accessing a frozen problem work area screen, accessing a tutoring work area screen, accessing a remedial work area screen, accessing a user identity associated with a tutor application, accessing a user identity associated with the student application, granting zero, partial, full, or extra credit to a correct problem answer, certifying a user identity associated with a teacher application, and combinations thereof.

12. The method of claim 6 further comprising:
monitoring the tutor application; and,
granting tutoring credits to a user identity associated with the tutor application.

13. The method of claim 12 wherein granting credits to a user identity associated with the tutoring software application includes granting credits selected from a group consisting on financial credits, school credits, and community service hours.

14. The method of claim 12 wherein the student application selecting the problem from the problem set screen includes selecting a plurality of problems;
wherein the student application submitting the problem answer includes the education program creating an answer screen associated with student application, distinguishing:
a first plurality of correct answers submitted without accessing a collaborative learning resource;
a second plurality of correct problem answers submitted in response to accessing a collaborative leaning resource; and,
a third plurality of incorrect problem answers.

15. The method of claim 6 wherein the tutoring application establishing a network connection with the education program includes reporting availability to accept tutor requests, and receiving credit even when no tutor requests are submitted by the student application in response to reporting availability.

16. A method for using a networked computer to provide anonymous tutoring, the method comprising:
a tutor computing device establishing a network connection with an education server having an education program embedded in a non-transitory memory as a sequence of processor executable instructions;
a tutor application, embedded in a tutor computing device non-transitory memory as a sequence of processor executable instructions, receiving a tutor request from the education program, the tutor request anonymously linked to a student application network-connected with the education program, where student applications are embedded in a non-transitory memory of a student computing device as a sequence of processor executable instructions;
the tutor application accepting a first tutor request anonymously associated with a first student application;
the tutor application accessing a first tutoring work area screen associated with the first tutor request; and,
the tutor application interactively populating the first tutoring work area screen as it is transceived with first student application.

17. A system for providing remote collaborative learning resources, the system comprising:
an education server comprising:
a processor;
a non-transitory memory embedding an education program enabled as a sequence of processor executable instructions;
a network interface;
a student computing device comprising:
a processor;
a non-transitory memory embedding a student application enabled as a sequence of processor executable instructions;
a network interface connected to the education server; and,
wherein the student application accesses an education program problem set screen, selects problems from the problem set screen, accesses collaborative learning resources associated with the selected problems, where the collaborative learning resources are selected from a group consisting of example work sheets and anonymous tutoring, and submits a corrected problem answer subsequent to accessing an associated collaborative learning resource.

18. The system of claim 17 wherein the student application submits a tutor request to the education program;
wherein the education program anonymously links the tutor request to the student application, and lists the tutor request on a tutoring billboard;
the system further comprising:
a tutor computing device comprising:
a processor;
a non-transitory memory embedded with a tutoring application enabled as a sequence of processor executable instructions;
a network interface connected to the education server; and,
wherein the tutoring application accesses the tutoring billboard, selects the tutor request, and interactively populates a tutoring work area screen, anonymously transceived with the student application via the education program.

19. The system of claim 18 wherein the tutoring application accesses the education program and automatically becomes certified to communicate with student applications in response to successfully passing a qualification test.

20. The system of claim 18 wherein the tutoring application anonymously transceives the tutoring work area screen with the student application in a manner selected from a group consisting of asynchronously or in real-time.

21. The system of claim 17 wherein the student application accesses a first problem work area screen associated with the first problem, enters data into the first problem work area screen, and prior to accessing a collaborative learning resource, submits the first problem work area screen with the first problem answer.

22. The system of claim 17 further comprising:
a teacher computing device comprising:
a processor;
a non-transitory memory including an embedded teacher application enabled as a sequence of processor executable instructions;
a network interface connected to the education server;
wherein the teacher application performs a function selected from a group consisting of accessing a frozen problem work area screen, accessing a tutoring work area screen, accessing a remedial work area screen, accessing a user identity associated with a tutor application, accessing a user identity associated with a first student application, granting zero, partial, full, or extra credit for a problem answer, certifying a user identity associated with a tutoring application, and combinations thereof.
